(19) United States
(12) Patent Application Publication
(10) Pub. No.: US 2025/0306195 A1
(43) Pub. Date: Oct. 2, 2025

(54) OCCUPANCY DETECTION USING RADAR

(71) Applicant: Texas Instruments Incorporated, Dallas, TX (US)

(72) Inventors: Muhammet Emin Yanik, Plain City, UT (US); Anil Varghese Mani, McKinney, TX (US)

(21) Appl. No.: 19/079,072

(22) Filed: Mar. 13, 2025

Related U.S. Application Data
(60) Provisional application No. 63/571,921, filed on Mar. 29, 2024.

(30) Foreign Application Priority Data
Sep. 9, 2024 (IN) 202441067979

(51) Int. Cl. G01S 13/56; B60N 2/00; G01S 7/41

(52) U.S. Cl. CPC G01S 13/56; B60N 2/0024; G01S 7/415

(57) ABSTRACT

An example method includes: computing a difference metric between first sensed data and second sensed data, wherein the first sensed data is associated with a first region in a field of view of a sensor, and wherein second sensed data is associated with a second region in the field of view; determining that the first sensed data is distinguishable from the second sensed data using the difference metric; and detecting occupancy in the first region in response to determining that the first sensed data is distinguishable from the second sensed data.

### CROSS-REFERENCE TO RELATED APPLICATION

This patent application claims the benefit of and priority to U.S. Provisional Patent Application No. 63/571,921, filed Mar. 29, 2024, and Indian Provisional Patent Application No. 20/244,1067979, filed Sep. 9, 2024, each of which is hereby incorporated herein by reference in its entirety.

### TECHNICAL FIELD

This description relates generally to occupancy detection and, more particularly, to methods and apparatus to detect occupancy using radar.

### BACKGROUND

Electronic sensors produce electrical signals representing characteristics of an environment. Radar systems sense objects by transmitting and receiving radio waves. Radar systems compare transmitted waves to received waves to determine the location, size, and motion of objects in the environment. Some devices use radar data from received waves to accurately detect changes to a surrounding environment, such as object motion tracking, new object detection, etc.

### SUMMARY

For methods and apparatus to detect occupancy using radar, an example method includes computing a difference metric between first sensed data and second sensed data, where the first sensed data is associated with a first region in a field of view of a sensor, and where second sensed data is associated with a second region in the field of view. The method includes determining that the first sensed data is distinguishable from the second sensed data using the difference metric. The method includes detecting occupancy in the first region in response to determining that the first sensed data is distinguishable from the second sensed data. Other examples are described.

For methods and apparatus to detect occupancy using radar, an example at least one non-transitory computer readable storage medium including instructions to compute a difference metric between first sensed data and second sensed data, where the first sensed data is associated with a first region in a field of view of a sensor, and where second sensed data is associated with a second region in the field of view. The at least one non-transitory computer readable storage medium includes instructions to determine that the first sensed data is distinguishable from the second sensed data using the difference metric. The at least one non- transitory computer readable storage medium includes detect occupancy in the first region in response to determining that the first sensed data is distinguishable from the second sensed data. Other examples are described.

For methods and apparatus to detect occupancy using radar, an example method includes determining a distribution metric of first radar data associated with a reference zone. The method includes determining a difference metric between the distribution metric of the first data and second radar data associated with a target zone. The method includes detecting occupancy in the target zone using the difference metric. Other examples are described.

### BRIEF DESCRIPTION OF THE DRAWINGS

FIGS. 1A and 1B are a block diagram of an example vehicle having a reference zone and target zones.

FIGS. 2A, 2B, and 2C are block diagrams of example radar data in the example zones of the vehicle of FIGS. 1A and 1B.

FIGS. 3A and 3B are a block diagram of the example vehicle of FIGS. 1A, 1B, 2A, 2B, and 2C having a reference zone and alternative target zones.

FIG. 4 is a block diagram of an example radar system including example occupancy detection circuitry.

FIGS. 5A and 5B form a block diagram of another example radar system including the example occupancy detection circuitry of FIG. 4.

FIG. 6 is a block diagram of an example of the occupancy detection circuitry of FIGS. 4, 5A, and 5B.

FIG. 7 are plots of example radar signal-noise ratio (SNR) data.

FIG. 8 are example plots of radar SNR and Doppler data.

FIG. 9 is a plot of an example range-azimuth-elevation grid.

FIGS. 10A and 10B are plots of an example assignment of the radar SNR and Doppler data of FIG. 8 from the example range-azimuth-elevation grid of FIG. 9 to the reference zone and the target zones of the vehicle of FIGS. 1A and 1B.

FIG. 11 is a flowchart representative of example machine-readable instructions or example operations that may be at least one of executed, instantiated, or performed using an example programmable circuitry implementation of the occupancy detection circuitry of FIGS. 4, 5A, 5B, and 6 or more generally the radar systems of FIGS. 4, 5A, and 5B.

FIGS. 12A, 12B, and 12C are plots of example occupancy detections in the example vehicle of FIGS. 3A and 3B.

FIGS. 13A and 13B are plots of example difference metrics for occupancy detection using radar SNR and Doppler data.

FIG. 14 is a plot of example operations of the radar system of FIG. 4 with objects near the vehicle of FIGS. 3A and 3B.

FIG. 15 is a plot of example operations of the radar system of FIG. 4 with objects near the vehicle of FIGS. 3A and 3B.

FIG. 16 is a block diagram of another example of the occupancy detection circuitry of FIGS. 4, 5A, 5B, and 6 for filtering local peaks and sidelobes.

FIGS. 17A, 17B, and 17C are a plot of example operations of the occupancy detection circuitry of FIG. 16 filtering local peaks and sidelobes.

FIG. 18 is a plot of example operations of the radar system of FIG. 4 with objects near the vehicle of FIGS. 3A and 3B after the occupancy detection circuitry of FIG. 16 filtering local peaks.

FIG. 19 is a block diagram of an example vehicle having a reference zone and target zones for child detection.

FIGS. 20A, 20B, and 20C are plots of example operations of the radar systems of FIGS. 4, 5A, and 5B, and 6 with the reference zone and target zones of FIG. 19.

FIG. 21 is a block diagram of an example processing platform including programmable circuitry structured to execute, instantiate, or perform the example machine-readable instructions or perform the example operations of FIG. 11 to implement the occupancy detection circuitry of FIGS. 4, 5A, 5B, 6, and 16.

FIG. 22 is a block diagram of an example implementation of the programmable circuitry of FIG. 21.

FIG. 23 is a block diagram of another example implementation of the programmable circuitry of FIG. 21.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Electronic sensors produce electrical signals representing characteristics of an environment. Radar systems sense objects by transmitting and receiving radio waves. Radar systems compare transmitted waves to received waves to determine the location, size, and motion of objects in the environment. Some devices use radar data from received waves to accurately detect changes to a surrounding environment, such as object motion tracking, new object detection, etc.

Some radar systems use 3D range-angle-Doppler estimations to determine motion of an object across a plurality of frames. A frame is a sequence of transmitting and receiving waves. In operation, transmitted waves reflect off objects to produce reflected waves. The radar system produces radar data representing the reflected waves. The radar data may include range, azimuth, elevation, and/or Doppler shift of the object. The range represents the distance between the radar sensor and the object that reflected the wave. The azimuth is an angle (e.g., a horizontal angle) of the object in relation to the radar sensor. The elevation represents an angle (e.g., a vertical angle) of the object in relation to the radar sensor. The Doppler shift is a change in frequency of the reflected wave, which represents a velocity of the object relative to the radar sensor.

Radar systems use the Doppler shift represented in the radar data to determine a velocity of an object with a relatively high resolution. These velocities are representative of movements of the object in the environment. Combining the Doppler shift with one or more of the range, azimuth, and/or elevation radar data allows the radar system to localize the motion in the environment. Further processing of the radar data may be used to perform a wide range of tasks.

In vehicle systems (e.g., automotive systems, aircraft, or boats), placing radar sensors inside of a cabin (also referred to as in-cabin radar sensors) allows vehicles to perform a wide range of additional sensing tasks. For example, an in-cabin radar system can sense passenger presence. Passenger presence may be used for issuing seatbelt reminders, indicating the presence of child, indicating a malicious intrusion into the vehicle, etc. The radar systems perform such tasks by detecting and localizing motion within the vehicle. Some in-cabin radar systems remove static radar data, which is radar data relevant to objects with no motion, to reduce the complexity of processing the radar data for a given task. For example, if a radar system is performing a motion detection task, the radar system can filter out radar data indicative of no velocity to simplify processing operations. In such examples, the radar system considers the remaining data to represent motion within the environment.

In some systems, such as automotive, once the static radar data is removed the remaining radar data may inaccurately represent motion in the surrounding environment when, in fact, no motion is present. For example, if the radar system is in a vehicle, external conditions such as engine vibrations, vehicle shaking due to wind, an earthquake, or a force of a passing vehicle, etc., may cause the radar system to produce radar data indicating motion in the environment. However, these external conditions of the vehicle do not correspond to motion within the vehicle, and result in false motion data. Radar data indicating false motions can produce false alarms in the sensing tasks. Other radar use-cases such as wall- or ceiling-mounted radar in buildings (e.g., light fixtures, security/surveillance devices, etc.), heating, ventilation, and air conditioning (HVAC)-based radar, fan-based radar, or vehicle-exterior radar may also experience relative motion across the entire field of view. For example, a building-mounted radar or a HVAC-mounted radar may shake when the wall, ceiling, or HVAC unit shakes; meanwhile, the objects within the field of view of the radar may be relatively motionless. The radar will sense the relative motion of the objects through Doppler processing.

Some radar systems use deep learning data models, such as convolutional neural networks (CNNs), to filter the false motion data from the radar data. For example, a radar system may form a point cloud using the localization of points in motion. In such examples, the radar system provides the point cloud to a deep learning data model for processing. However, deep learning data models need substantially more compute resources than a traditional radar system may have available. As safety regulations continue to expand, radar systems need to filter false motion data without substantially increasing compute resources or cost.

Examples described herein include methods and apparatus to detect occupancy using radar. As described above, implementing radar in some systems, such as vehicles, increases a likelihood of different conditions producing radar data having false motions. The examples described herein include radar systems having occupancy detection circuitry. The occupancy detection circuitry reduces the impact of false motion radar data when performing radar tasks, such as determining occupancy, child detection, intrusion detection, etc. In some examples, the occupancy detection circuitry partitions a vehicle into a plurality of zones. For example, the occupancy detection circuitry divides the vehicle into a reference zone and four target zones. The reference zone may be chosen as a region where an intrusion is not expected (e.g., a region not adjacent to a window of the vehicle) or a region where a child is not expected (e.g., a driver seat). The occupancy detection circuitry localizes the radar data to associate SNR and/or Doppler data with the reference or target zones. For example, first zone data includes radar data corresponding to the location of a reference zone and second zone data includes radar data corresponding to the location of a target zone.

In example operations, the occupancy detection circuitry determines one or more distribution metrics of data associated with the reference zone. In some examples, the distribution metrics include a mean and covariance. The occupancy detection circuitry computes a distance metric for data associated with the reference zone(s). In some examples, the distance metric is a Mahalanobis distance, which represents a statistical difference between localized data in the target zone and the distribution metric(s) of the reference zone.

In such example operations, the occupancy detection circuitry averages the distance metrics of all localized data each respective one of the target zones to produce an average distance metric for each target zone. The occupancy detection circuitry compares the average distance metric of the target zones to a threshold to determine occupancy in the respective target zone. For example, the occupancy detection circuitry determines an occupant is in a first target zone responsive to the average distance metric of the first target zone being greater than the threshold.

In some examples, the occupancy detection circuitry may modify the target and reference zones to perform different radar sensing tasks. For example, for an intrusion detection task, the reference zone is a central location in the vehicle and the target zones surround entry ways into the vehicle, such as doors, windows, etc. In another example, for a child detection task, the reference zone encloses the driver seat and the target zones enclose the passenger and back seats. In such examples, the driver seat is a highly unlikely location of the child and the target zones are likely locations of the child.

Advantageously, the distance metric represents an association of motion in the target zones to motion in the reference zone. Advantageously, the distance metric allows the occupancy detection circuitry to distinguish motions in the reference zone from motions in the target zone. Advantageously, using the distance metric for occupancy detection allows the radar system to filter false motion resulting from conditions of the environment. Advantageously, modifying the partition of an environment into different reference and target zones allows the occupancy detection circuitry to perform a wide range of radar tasks with fewer false positives, when compared to other radar processing approaches.

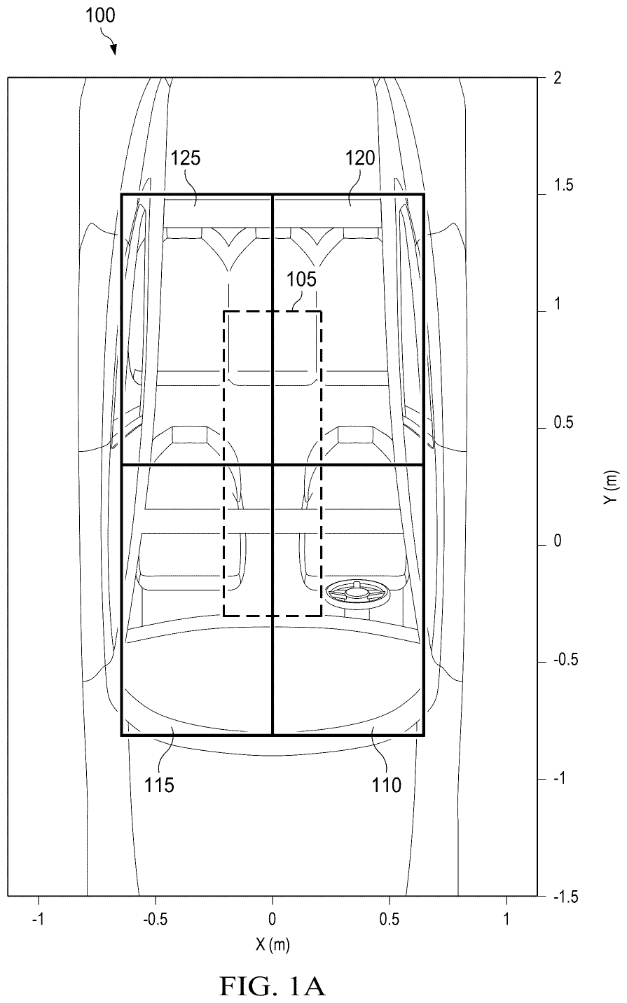

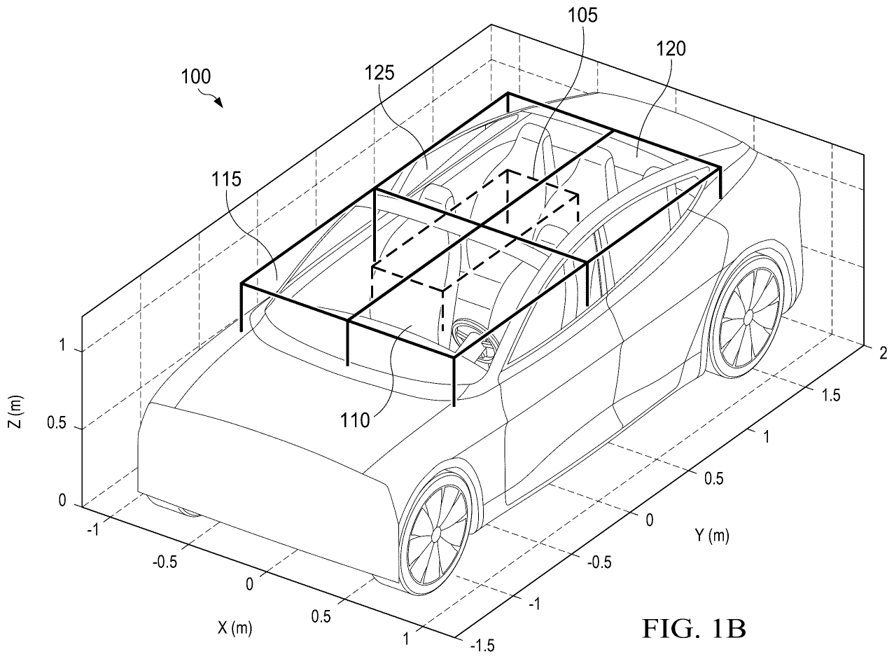

FIGS. 1A and 1B are a block diagram of an example vehicle 100 having a reference zone 105, a first target zone 110, a second target zone 115, a third target zone 120, and a fourth target zone 125. FIG. 1A is a top view of the vehicle 100 and the zones 105, 110, 115, 120, 125. FIG. 1B is an isometric view of the vehicle 100 and the zones 105, 110, 115, 120, 125. In the example of FIGS. 1A and 1B, the zones 105, 110, 115, 120, 125 span the in-cabin portions of the vehicle 100.

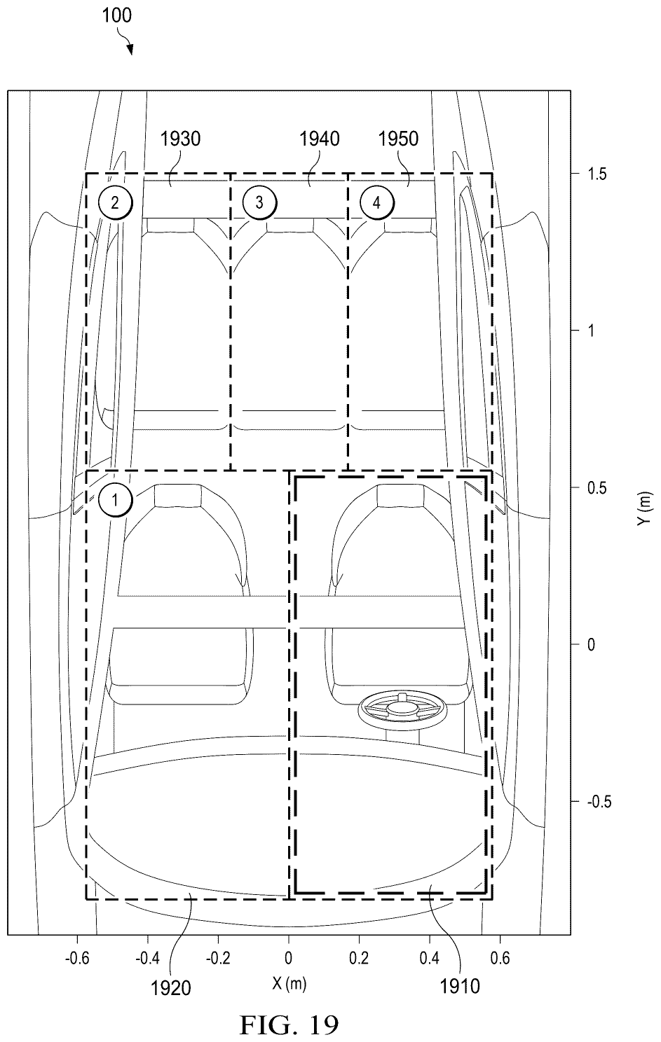

The reference zone 105 encloses a central location of the vehicle 100. In some examples, the location of the reference zone 105 is in portion(s) of the vehicle 100 likely not occupied, such as a center console, dashboard, footwell, portion of a back seat, etc. Also, the reference zone 105 does not include a portion of the vehicle 100 where an entry event is likely to occur. For example, the reference zone 105 does not enclose a portion of the vehicle 100 that has access to a window, door, trunk, etc. In such examples, an entry event of the vehicle 100, such as a passenger entering, a hand through an open window, etc., is highly unlikely to occur in the reference zone 105. In the examples of FIGS. 1A and 1B, changes in radar data in the reference zone 105 are likely the result of an external condition of the vehicle 100, such as vibrations from an engine, wind shaking the vehicle, vibrations of the road, etc. Advantageously, radar data associated with the reference zone 105 provides a refence to the condition of motions of the vehicle 100. Alternatively, in some examples, one of the target zones 110, 115, 120, 125 may be selected as a reference zone for an alternative type of occupancy detection, such as driver detection, child detection, etc. Such an example is further illustrated and described in connection with FIG. 19.

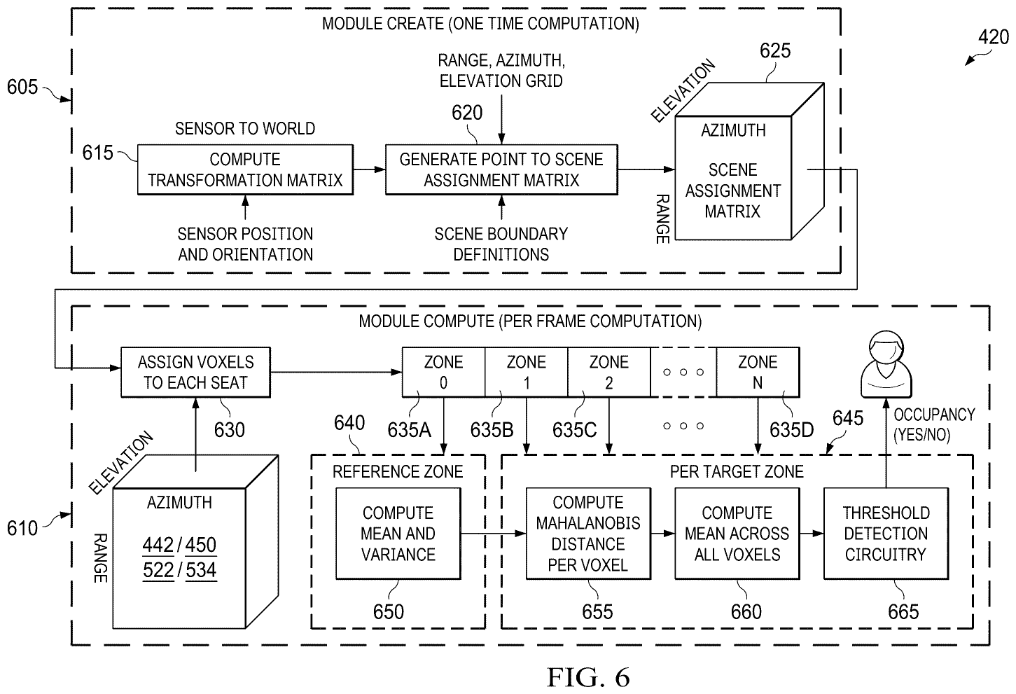

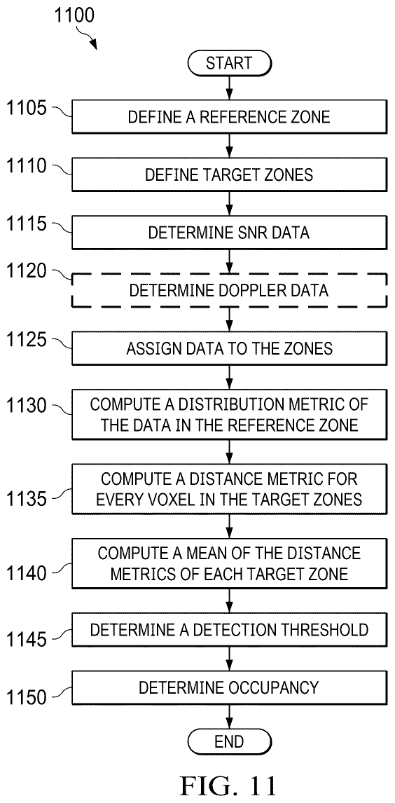

The target zones 110, 115, 120, 125 enclose the perimeter of the vehicle 100. In some examples, the locations of the target zones 110, 115, 120, 125 are in portions of the vehicle 100 that are likely occupied. For example, the target zone 110 encloses a driver seat and a front driver side portion of the vehicle 100, the target zone 115 encloses a passenger seat and a front passenger side portion of the vehicle 100, the target zone 120 encloses a back driver side portion of the vehicle 100, and the target zone 125 encloses a back passenger side portion of the vehicle 100. Also, the target zones 110, 115, 120, 125 include portions of the vehicle 100 where an entry event is likely to occur, such as a window, door, trunk access, etc. In such examples, a change in occupancy of the vehicle 100 is likely to occur in one of the target zones 110, 115, 120, 125. For example, a malicious entry through a window of the vehicle 100 is likely to occur in one or more of the target zones 110, 115, 120, 125. Advantageously, radar data associated with the target zones 110, 115, 120, 125 may change with the condition of the vehicle 100 or an occupancy of the vehicle 100. Advantageously, as further described in FIGS. 6 and 11, a comparison of radar data of the reference zone 105 to radar data of the target zones 110, 115, 120, 125 allows a radar system to differentiate between occupancy and changes in the condition of the vehicle 100.

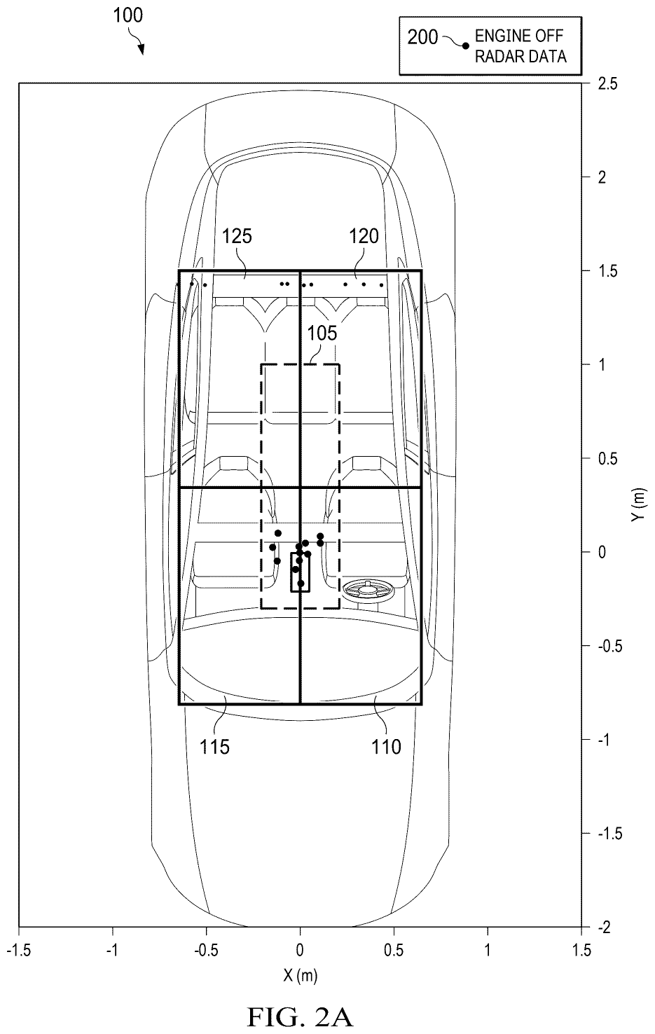

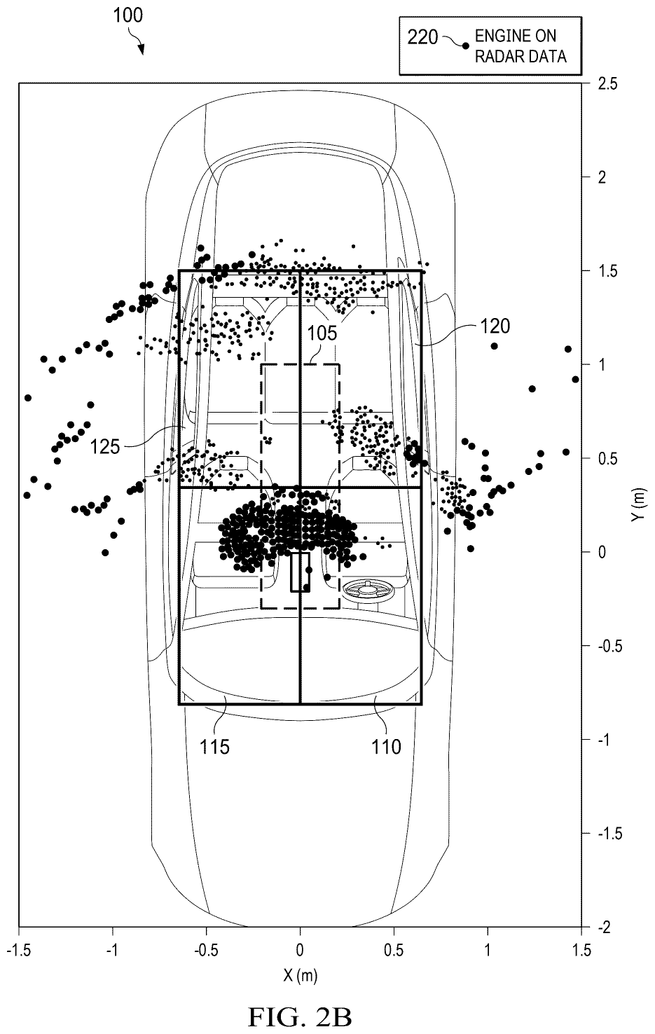

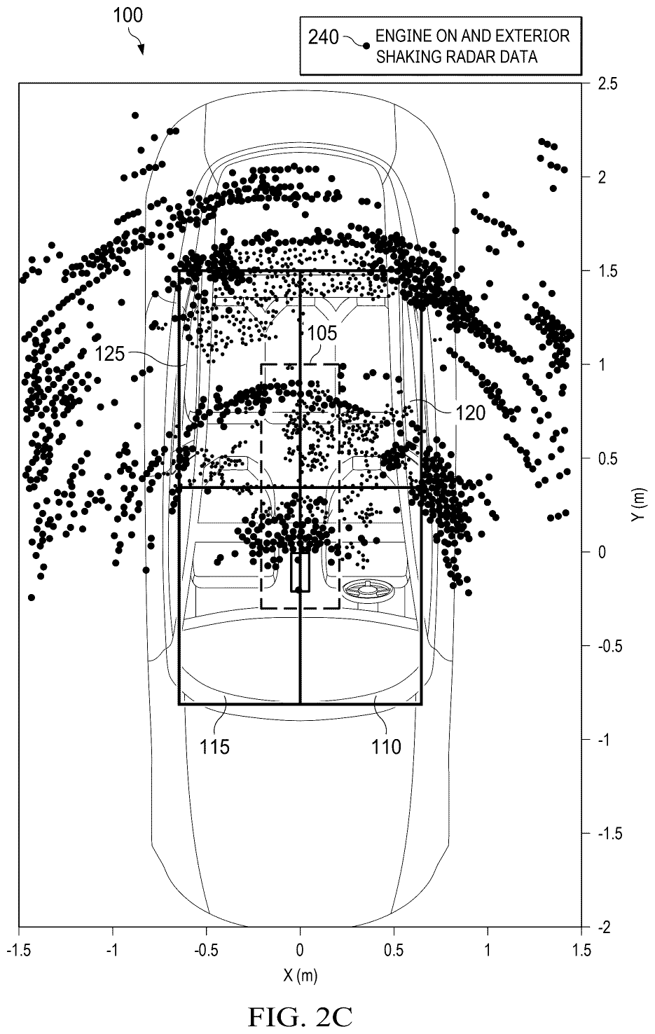

FIGS. 2A, 2B, and 2C are block diagrams of the example radar data 200, 220, 240 in the example zones 105, 110, 115, 120, 125 of FIGS. 1A and 1B of the example vehicle 100 of FIGS. 1A and 1B. The radar data 200, 220, 240 represents the localization of objects in the vehicle 100 that are in motion across a reference interval. For example, the radar data 200 represents points of motion in the vehicle 100 across a thirty second reference interval.

In the example of FIG. 2A, the radar data 200 represents points of motion during the condition in which the engine of the vehicle 100 is off. In the example of FIG. 2B, the radar data 220 represents points of motion during the condition in which the engine of the vehicle 100 is on. In the example of FIG. 2C, the radar data 240 represents points of motion during the conditions where the engine of the vehicle 100 is on and an external force is shaking the vehicle 100. For example, the radar data 240 represents when the engine of the vehicle 100 is on and wind shakes the vehicle 100. In the examples of FIGS. 2A, 2B, and 2C, conditions of the vehicle 100, such as the state of the engine, external shaking, etc., adversely effects points in the reference zone 105. Similarly, the conditions of FIGS. 2B and 2C disproportionately affect the radar data 220, 240 in the target zones 110, 115, 120, 125.

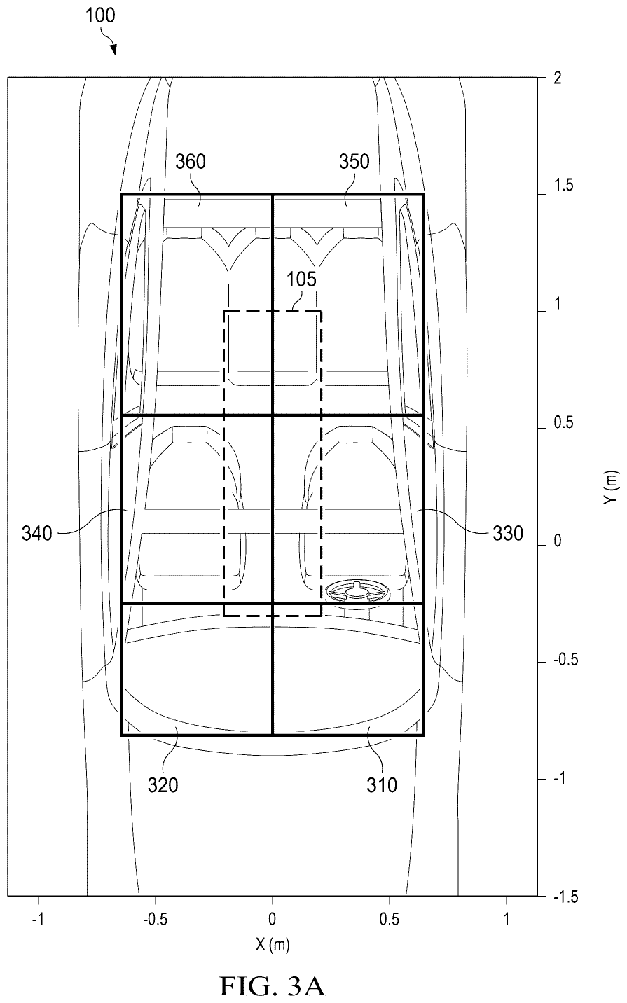

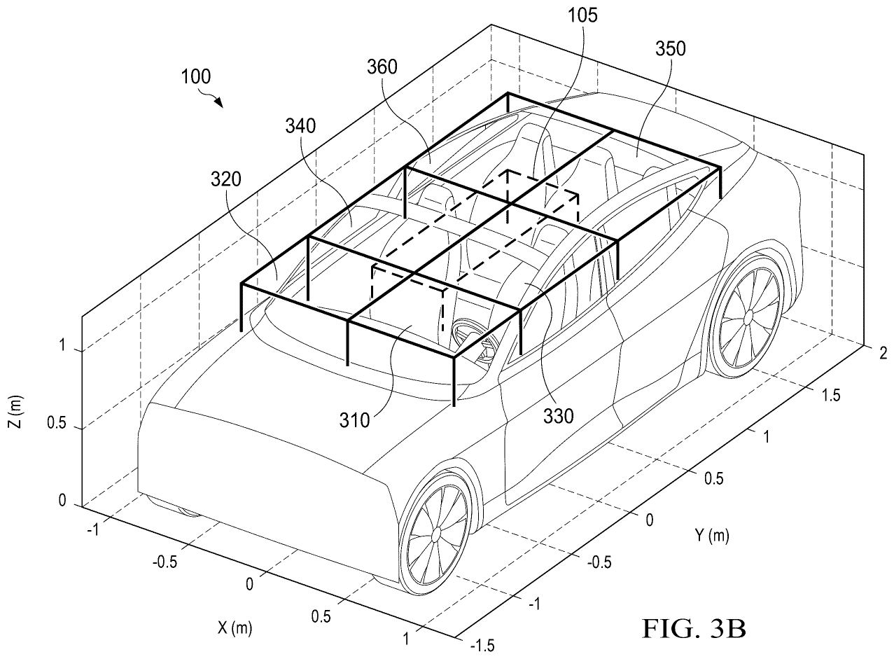

FIGS. 3A and 3B are a block diagram of the example vehicle 100 of FIGS. 1A, 1B, 2A, 2B, and 2C having the reference zone 105 of FIGS. 1A, 1B, 2A, 2B, and 2C, a first target zone 310, a second target zone 320, a third target zone 330, a fourth target zone 340, a fifth target zone 350, and a sixth target zone 360. The target zones 310, 320, 330, 340, 350, 360 are alternatives to the target zones 110, 115, 120, 125 of FIGS. 1A, 1B, 2A, 2B, and 2C. Advantageously, the in-cabin portion of the vehicle 100 may be divided into any number of target zones.

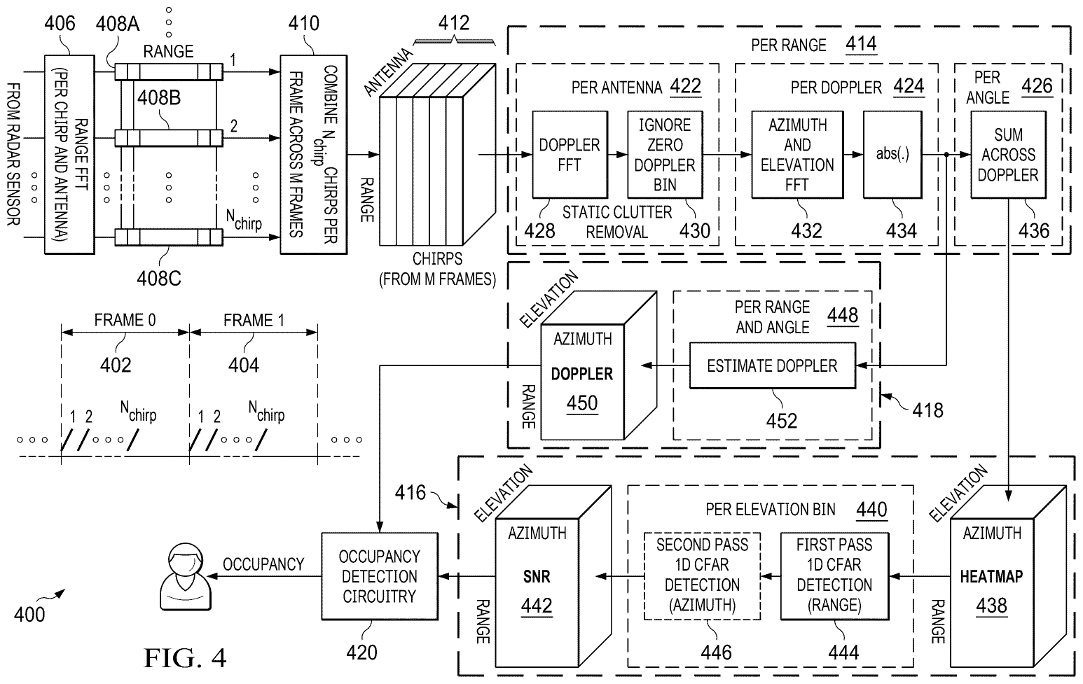

FIG. 4 is a block diagram of an example radar system 400 which uses an in-cabin vehicle radar for occupancy detection. In the example of FIG. 4, the radar system 400 includes a first example frame 402, a second example frame 404, example range FFT circuitry 406, example range data 408A, 408B, 408C, example combination circuitry 410, example range data array 412, example per range circuitry 414, example SNR circuitry 416, example Doppler circuitry 418, and example occupancy detection circuitry 420. The example per range circuitry 414 of FIG. 4 includes per antenna Doppler circuitry 422, per Doppler circuitry 424, per angle circuitry 426, Doppler FFT circuitry 428, Doppler filter circuitry 430, azimuth and elevation FFT circuitry 432, absolute value circuitry 434, and Doppler sum circuitry 436. The example SNR circuitry 416 of FIG. 4 includes a heatmap 438, per elevation circuitry 440, radar signal-noise ratio (SNR) data 442, first constant false alarm rate (CFAR) detection circuitry 444, and second CFAR detection circuitry 446. The example Doppler circuitry 418 of FIG. 4 includes example per range and angle circuitry 448, example Doppler data 450, and example Doppler estimate circuitry 452.

The frames 402, 404 (FRAME 0, FRAME 1) represent a sequence of operations of the radar system 400 to produce radar data. During the frames 402, 404, a radar sensor transmits radio wave(s) across a range of frequencies. In some examples, a radio wave of a specific frequency is referred to as a chirp. During the frames 402, 404, the radar system 400 produces N number of chirps spanning a range of frequencies.

The range FFT circuitry 406 converts received signals from a time domain to a frequency domain. The range FFT circuitry 406 produces the range data 408A, 408B, 408C by converting received waves into the frequency domain. The range data 408A, 408B, 408C represents distances of objects across the chirps of the frames 402, 404, which is referred to as range. In some examples, the range FFT circuitry 406 stores the range data 408A, 408B, 408C for a plurality of antennas of the radar system 400.

The combination circuitry 410 produces the range data array 412 using multiple instances of the range data 408A, 408B, 408C across a plurality of frames, such as the frames 402, 404. For example, the combination circuitry 410 populates the range data array 412 with the instances of the range data 408A, 408B, 408C produced across the frames of a thirty second window. In some examples, the range data array 412 stores range data for each antenna of the radar system 400 across M number of frames.

The per range circuitry 414 receives the range data array 412. The per range circuitry 414 produces data having a range, azimuth, and elevation using the range data array 412. In example operations, the per range circuitry 414 operates on each respective instance of the range data array 412. For example, if the range data array 412 represents ten frames, the per range circuitry 414 may operate once per ten frames. Also, the per range circuitry 414 uses a series of 2D FFTs to process the range data array 412. Such systems are referred to as implementing a 2D FFT processing chain.

In example operations of the per range circuitry 414, the per antenna Doppler circuitry 422 produces Doppler vectors for the range data array 412 using an FFT. The per antenna Doppler circuitry 422 also filters out range data for locations that are not in motion. The Doppler FFT circuitry 428 produces the Doppler vectors using the range data of the range data array 412. A Doppler vector represents a motion of a point across the frames represented by the range data array 412. The Doppler filter circuitry 430 removes associated with a Doppler vector of approximately zero. Advantageously, a Doppler vector of approximately zero corresponds to data not in motion. The per antenna Doppler circuitry 422 filters the range data array 412 to remove data that is not associated with motion.

In example operations of the per range circuitry 414, the per Doppler circuitry 424 receives the filtered range data array. The per Doppler circuitry 424 converts the remaining data of the range data array 412 into azimuth and elevation coordinates. In some examples, the azimuth and elevation FFT circuitry 432 computes azimuth and elevation FFTs on the range data array 412. The absolute value circuitry 434 computes the absolute values of the data of the radar data. The per Doppler circuitry 424 provides the Doppler data in terms of range, azimuth, and elevation to the Doppler circuitry 418.

Also, in example operations of the per range circuitry 414, the per angle circuitry 426 receives the radar data in terms of range, azimuth, and elevation. In such examples, the radar data is a plurality of Doppler vectors. The Doppler sum circuitry 436 combines Doppler vectors for each angle. The Doppler sum circuitry 436 produces the heatmap 438 to represent the sum of Doppler vectors based on range, azimuth, and elevation.

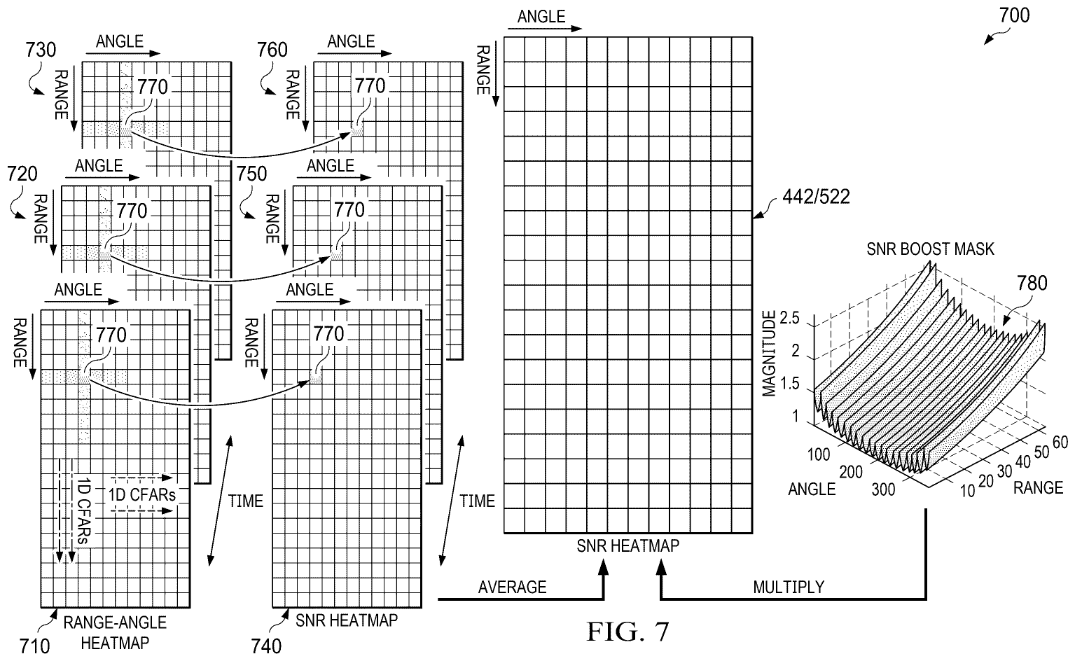

The SNR circuitry 416 receives the heatmap 438 from the per range circuitry 414. The heatmap 438 represents radar data in terms of range, azimuth, and elevation. The SNR circuitry 416 produces the radar SNR data 442 using the heatmap 438. In example operations of the SNR circuitry 416, the per elevation circuitry 440 ratios each signal value to surrounding signal values to produce the radar SNR data 442. The CFAR detection circuitry 444 ratios each signal value to nearby signal values along the range axis. Similarly, the CFAR detection circuitry 446 ratios each Doppler signal value to nearby signal values Doppler along the azimuth axis. Alternatively, the CFAR detection circuitry 444, 446 may be illustrated or described as 2D CFAR detection circuitry. Alternatively, the CFAR detection 444, 446 may be modified or replaced with alternative logic to ratio points, such as histograms, etc. Example operations of the SNR circuitry 416 are further illustrated and described in connection with FIG. 7.

Similarly, the Doppler circuitry 418 receives Doppler vectors in terms of azimuth and elevation. The Doppler circuitry 418 produces the radar Doppler data 450 for each respective instance of the range data array 412. In example operations of the Doppler circuitry 418, the per range and angle circuitry 448 determines values that approximately represent the Doppler vectors. In some examples, the Doppler estimate circuitry 452 estimates the Doppler vector along the range and angle axis using the absolute values from the per range circuitry 414. The Doppler data 450 includes data representing the velocity of points localized by range, azimuth, and elevation. In some examples, the location of a maximum peak in the Doppler spectrum may be the estimated Doppler value. In some examples, the mean or median frequency of the Doppler spectrum can be used as the estimated Doppler value.

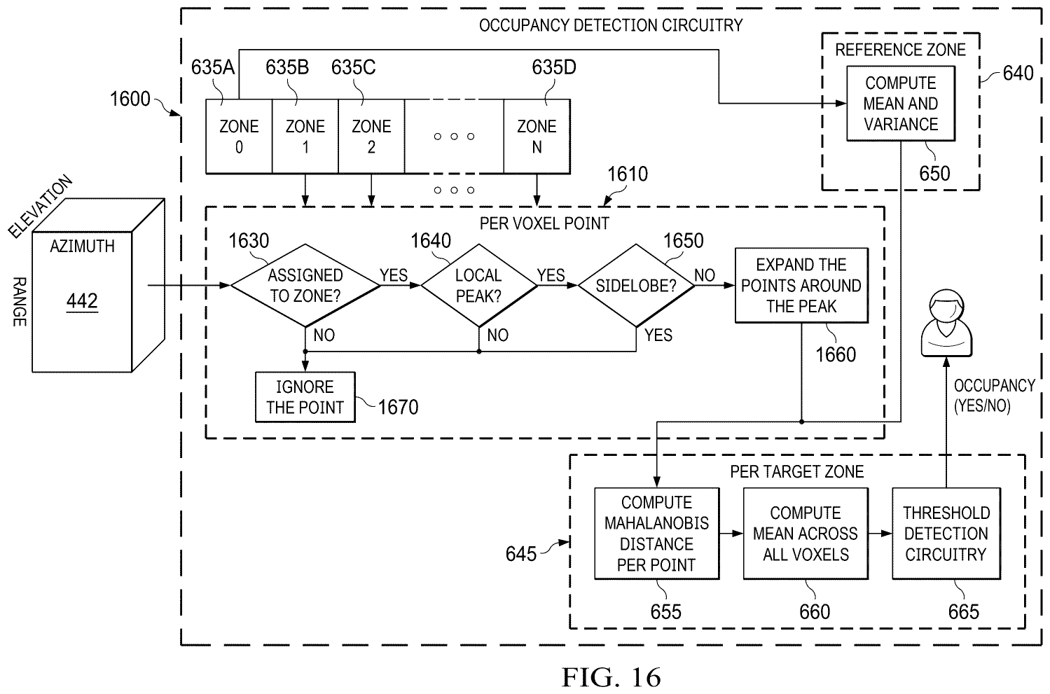

The occupancy detection circuitry 420 receives at least one of radar SNR data 442 or the radar Doppler data 450 from the SNR circuitry 416 and the Doppler circuitry 418. The occupancy detection circuitry 420 determines an occupancy in one of the target zones 110, 115, 120, 125, 310, 320, 330, 340, 350, 360 using the radar SNR and/or Doppler data. In some examples, the occupancy detection circuitry 420 provides an indication of occupancy to external circuitry. Examples of the occupancy detection circuitry 420 are further illustrated and described in connection with FIGS. 6 and 16.

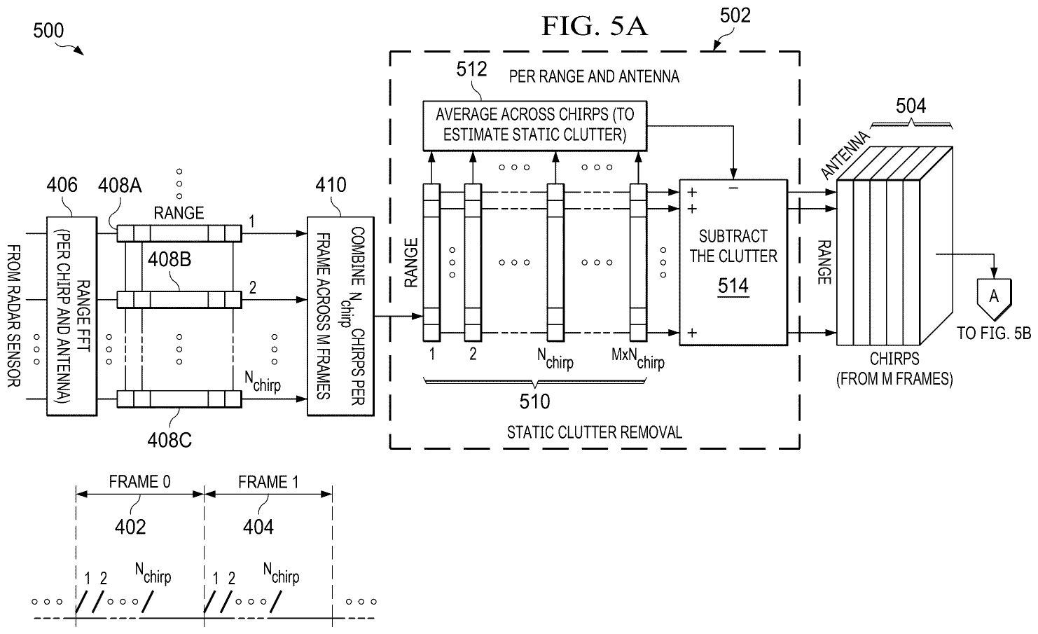

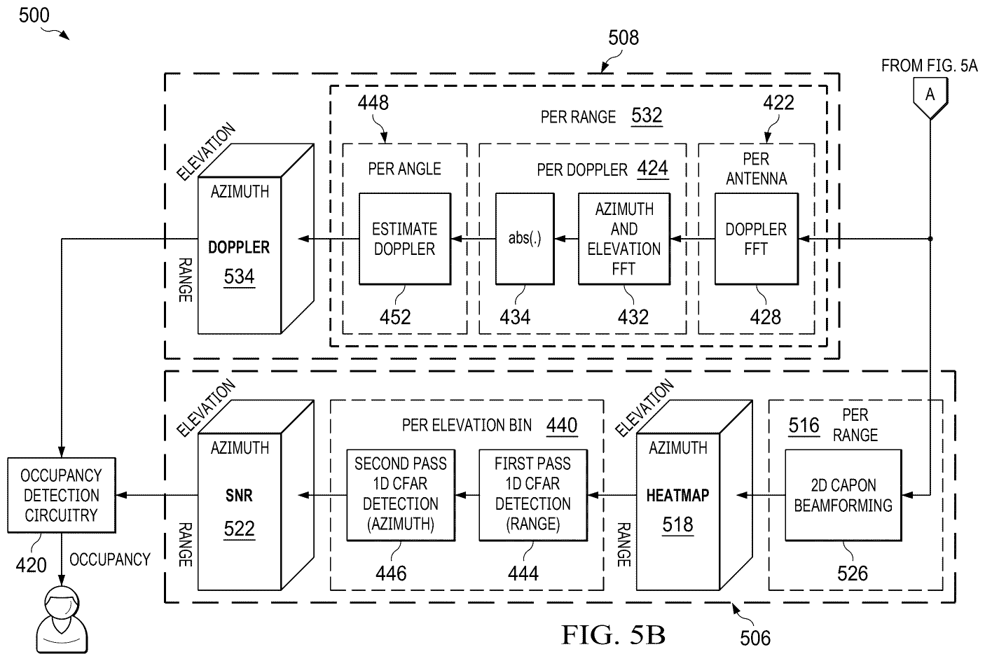

FIGS. 5A and 5B form a block diagram of an example radar system 500 which uses an in-cabin vehicle radar for occupancy detection. In the example of FIGS. 5A and 5B, the radar system 500 includes the frames 402, 404, the range FFT circuitry 406, the range data 408A, 408B, 408C, the combination circuitry 410, the occupancy detection circuitry 420, example per range and antenna circuitry 502, example range data array 504, example SNR circuitry 506, and example Doppler circuitry 508. The example per range and antenna circuitry 502 of FIG. 5A includes chirp data 510, averaging circuitry 512, and example subtraction circuitry 514. The example SNR circuitry 506 of FIG. 5B includes the per elevation circuitry 440, the CFAR detection circuitry 444, 446, the example per range circuitry 516, an example heatmap 518, example radar SNR data 522, and example beamforming circuitry 526. The example Doppler circuitry 508 of FIG. 5B includes the per antenna Doppler circuitry 422, the per Doppler circuitry 424, the Doppler FFT circuitry 428, the azimuth and elevation FFT circuitry 432, the absolute value circuitry 434, the per angle circuitry 448, the Doppler estimate circuitry 452, the example per range circuitry 532, and example Doppler data 534.

Similar to the radar system 400, the radar system 500 uses a radar sensor to receive the range data 408A, 408B, 408C for a plurality of radar frames, such as the frames 402, 404. Unlike the radar system 400, the combination circuitry 410 provides the range data 408A, 408B, 408C to the per range and antenna circuitry 502.

The per range and antenna circuitry 502 receives the range data 408A, 408B, 408C for a plurality of frames. The per range antenna circuitry 502 produces the chirp data 510 by collecting the range data 408A, 408B, 408C across a plurality of frames, such as the frames 402, 404. The averaging circuitry 512 determines an average of each chirp of the chirp data 510. The subtraction circuitry 514 subtracts the average of each chirp from the chirp data 510. The per range and antenna circuitry 502 produces the range data array 504 with the subtracted data. Advantageously, the per range and antenna circuitry 502 reduces static data by removing the average value of each chirp.

The SNR circuitry 506 receives radar data of the range data array 504. The SNR circuitry 506 produces the radar SNR data 522 using the range data array 504. Unlike the SNR circuitry 416, the SNR circuitry 506 uses beamforming to produce the heatmap 518. In some examples, the SNR circuitry 506 implements 2D capon, which is a method of beamforming to produce vectors. In example operations of the SNR circuitry 506, the per range circuitry 516 computes values of the heatmap 518 for each range of the range data array 504. For example, the beamforming circuitry 526 combines values of the radar data based on the location of an antenna and the angle of interest. For example, antennas directly in front of a received signal receive a higher weight than antennas farther away from the received signal. Such scaling of the radar data reduces interference from signals received by different antennas. The per range circuitry 516 produces the heatmap 518 having values representing a strength (e.g., amplitude) of a received signal. Similar to the SNR circuitry 416, the per elevation circuitry 440 produces the radar SNR data 522 from the heatmap 518. In example operations, the SNR circuitry 506 provides the radar SNR data 522 to the occupancy detection circuitry 420.

The Doppler circuitry 508 receives radar data of the range data array 504. Similar to the per range circuitry 414 of FIG. 4, the per range circuitry 532 produces the radar Doppler data 534 using the range data array 504. In example operations, the Doppler circuitry 508 provides the radar Doppler data 534 to the occupancy detection circuitry 420. Example operations of the occupancy detection circuitry 420 are further illustrated and described in connection with FIGS. 6 and 11.

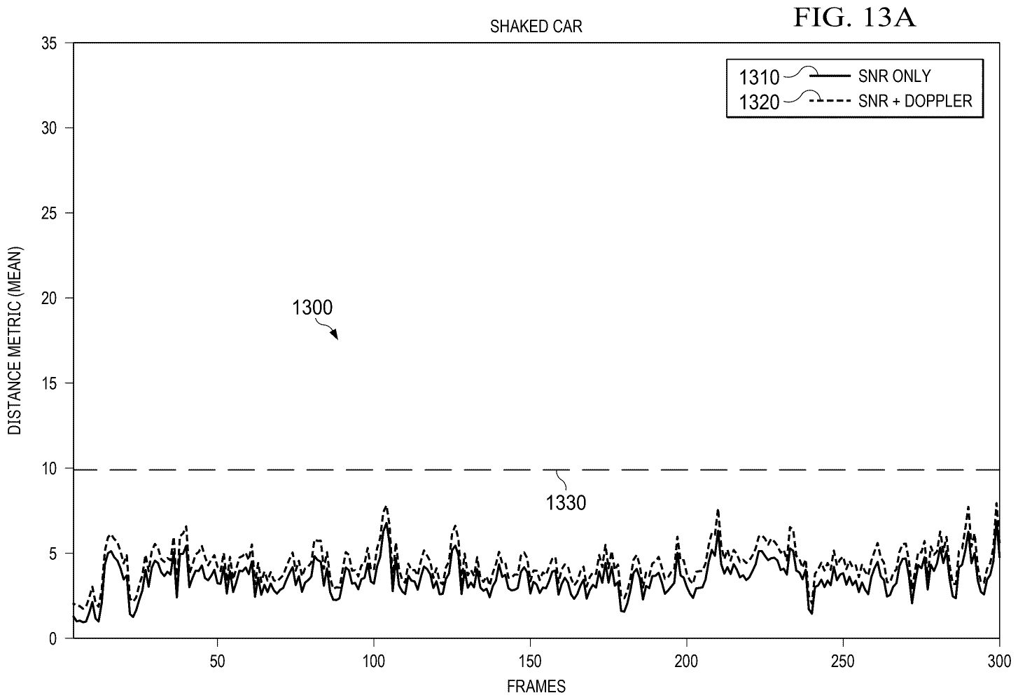

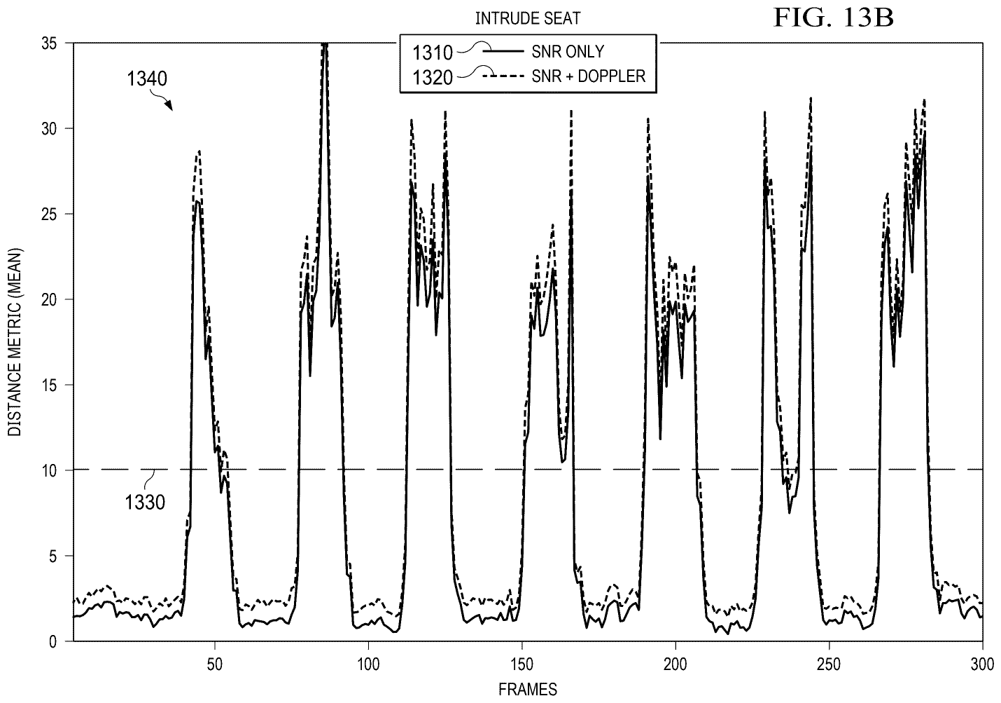

Advantageously, the radar systems 400, 500 provide the radar SNR data 442, 522 and the radar Doppler data 450, 534 to the occupancy detection circuitry 420. In some examples, as further described in connection with FIGS. 13A and 13B, the radar systems 400, 500 may provide only one of the radar SNR data 442, 522 or the radar Doppler data 450, 534 to the occupancy detection circuitry 420.

FIG. 6 is a block diagram of an example implementation of the occupancy detection circuitry 420 of FIGS. 4, 5A, and 5B, or more generally the radar systems 400, 500 of FIGS. 4, 5A, and 5B. The occupancy detection circuitry 420 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the occupancy detection circuitry 420 of FIG. 6 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 6 may, thus, be instantiated at the same or different times. Some or all of the circuitry of FIG. 6 may be instantiated, for example, in one or more threads executing concurrently on hardware or in series on hardware. Moreover, in some examples, some or all of the circuitry of FIG. 6 may be implemented by microprocessor circuitry executing instructions or FPGA circuitry performing operations to implement one or more virtual machines or containers.

In the example of FIG. 6, the occupancy detection circuitry 420 includes example module create circuitry 605 and example module compute circuitry 610. The example module create circuitry 605 of FIG. 6 includes transform compute circuitry 615, scene assignment circuitry 620, and a scene assignment matrix 625. In example operations of the module create circuitry 605, the transform compute circuitry 615 computes a transformation matrix using sensor position and orientation data. In some examples, the transform compute circuitry 615 is instantiated by programmable circuitry executing transform compute instructions to perform operations such as those represented by the flowchart of FIG. 11.

In such example operations, the scene assignment circuitry 620 generates the scene assignment matrix 625 by assigning points of a scene to the transformation matrix using scene boundary data, range data, azimuth data, and an elevation grid. In some examples, the scene assignment circuitry 620 is instantiated by programmable circuitry executing scene assignment instructions to perform operations such as those represented by the flowchart of FIG. 11. The scene assignment matrix 625 identifies which of the zone(s), such as the zones 105, 110, 115, 120, 125 of FIGS. 1A, 1B, 2A, 2B, and 2C, correspond to a given point.

The example module compute circuitry 610 of FIG. 6 includes voxel assignment circuitry 630, zone data 635A, 635B, 635C, 635D, reference zone circuitry 640, per target zone circuitry 645, reference compute circuitry 650, voxel difference compute circuitry 655, zone compute circuitry 660, and threshold detection circuitry 665. In example operations of the module compute circuitry 610, the voxel assignment circuitry 630 receives at least one of the radar SNR data 442, 522 or the Doppler data 450, 534 from the SNR circuitry 416, 506 and the Doppler circuitry 418, 508. The voxel assignment circuitry 630 assigns each voxel of the data 442, 450, 522, 534 to at least one of the zone data 635A, 635B, 635C, 635D using the scene assignment matrix 625. A voxel is localized data. The zone data 635A, 635B, 635C, 635D are subsets of the data 442, 450, 522, 534. For example, the voxel assignment circuitry 630 assigns data associated with locations in the reference zone 105 to the zone data 635A, radar data associated with locations in the target zone 110 to the zone data 635B, etc. In some examples, the voxel assignment circuitry 630 determines which one(s) of the zone data 635A, 635B, 635C, 635D to assign voxels of the data 442, 450, 522, 534 using corresponding assignments in the scene assignment matrix 625. In some examples, the voxel assignment circuitry 630 is instantiated by programmable circuitry executing voxel assignment instructions to perform operations such as those represented by the flowchart of FIG. 11.

The example operations of the reference zone circuitry 640 occur once per instance of the zone data 635A or more generally instance of the data 442, 450, 522, 534. In the example of FIG. 6, the zone data 635A corresponds to radar data in the reference zone 105. Accordingly, the reference zone circuitry 640 receives the zone data 635A. In example operations of the reference zone circuitry 640, the reference compute circuitry 650 determines at least one distribution metric, such as a mean, variance, etc., of the zone data 635A. In some examples, the reference compute circuitry 650 is instantiated by programmable circuitry executing reference compute instructions to perform operations such as those represented by the flowchart of FIG. 11. Although FIG. 6 depicts a single set of single reference zone, multiple reference zones may be used in some instances.

The example operations of the per target zone circuitry 645 occurs once for each target zone. For example, if the zone data 635B, 635C, 635D respectively represent one of the target zones 110, 115, 120, the per target zone circuitry 645 individually process each of the zone data 635B, 635C, 635D. In example operation of the per target zone circuitry 645, the voxel difference compute circuitry 655 determines a distance metric between data of each voxel of the zone data 635B, 635C, 635D and the distribution metric from the reference zone circuitry 640. In some examples, the voxel difference compute circuitry 655 determines a distance between values of the voxels and the mean or variance of the zone data 635A. In such examples, the distance between values represents a divergence from the variance of the zone data 635A. Such a distance is referred to as a Mahalanobis distance or M distance. The distance can be any other metric that represents the distinctiveness of one data set (e.g., zone data 635B) relative to another data set (e.g., zone data 635A). In some examples, the voxel difference compute circuitry 655 is instantiated by programmable circuitry executing voxel difference compute instructions to perform operations such as those represented by the flowchart of FIG. 11.

In such example operations of the per target zone circuitry 645, the zone compute circuitry 660 averages the distance metrics of all voxels of each respective one of the zone data 635B, 635C, 635D. For example, the zone compute circuitry 660 determines a first mean for distances of the zone data 635B, a second mean for distances of the zone data 635C, and a third mean for distances of the zone data 635D. In such example operations, the first mean corresponds to the target zone 110, the second mean corresponds to the target zone 115, and the third mean corresponds to the target zone 120. In some examples, the zone compute circuitry 660 is instantiated by programmable circuitry executing zone compute instructions to perform operations such as those represented by the flowchart of FIG. 11.

The threshold detection circuitry 665 compares the means of the zone compute circuitry 660 to a threshold value. In some examples, the threshold detection circuitry 665 detects occupancy in one of the target zones 110, 115, 120, 125 responsive to a determination that the mean distance is greater than the threshold value. In some examples, the threshold detection circuitry 665 is instantiated by programmable circuitry executing threshold detection instructions to perform operations such as those represented by the flowchart of FIG. 11. Advantageously, the per target zone circuitry 645 detects occupancy in one of the target zones 110, 115, 120, 125 using a statistical comparison of data of the target zones 110, 115, 120, 125 to the reference zone 105.

FIG. 7 are plots 700 of an example of the radar SNR data 442. In the example of FIG. 7, the radar systems 400, 500 receive a first heatmap 710, a second heatmap 720, and a third heatmap 730. The heatmaps 710, 720, 730 represent amplitudes of reflected signals based on a range and angle of the signal. In some examples, the radar system 400, 500 produces the heatmap 710 at a first time and responsive to first transmitted signal(s) from a radar sensor, the heatmap 720 at a second time and responsive to second transmitted signal(s), and the heatmap 730 at a third time and responsive to third transmitted signal(s). The per elevation circuitry 440 produces SNR heatmaps 740, 750, 760 using the heatmaps 710, 720, 730. In other examples, the radar system 400, 500 produces the SNR heatmaps 740, 750, 760 using a singular one of the heatmap 710, 720, 730. In such examples, the radar system 400, 500 processes the one of the heatmaps 710, 720, 730 with different CFAR parameters to produce the SNR heatmaps 740, 750, 760.

In some examples, the CFAR detection circuitry 444 ratios values of surrounding voxels to produce a corresponding SNR value of the SNR heatmaps 740, 750, 760. For example, the CFAR detection circuitry 444 produces a corresponding value of the voxel 770 in the SNR heatmap 740 by ratioing vectors near the voxel 770 in the heatmap 710. In some such examples, the CFAR detection circuitry 444 averages the surrounding data of each voxel of the heatmaps 710, 720, 730 to produce the SNR heatmaps 740, 750, 760.

In such example operations, the per elevation circuitry 440 averages the determined value of each voxel across the SNR heatmaps 740, 750, 760 to produce the radar SNR data 442. In such examples, the radar SNR data 442 represents the time taken to produce the heatmaps 710, 720, 730. Advantageously, the elevation of each voxel in the radar SNR data 442 corresponds to the signal-to-noise ratio of different locations within the vehicle 100. Advantageously, objects in the vehicle 100 are likely to reflect signals with a relatively high amplitude in comparison to external signals in the environment.

In example operations, distance between the radar system 400, 500 and an object may attenuate signals. In such example operations, signals traversing longer distances are likely to have lower magnitudes. In some examples, the radar system 400, 500 use an example SNR boost mask 780 to compensate for signal attenuation resulting from distance. In such examples, the SNR boost mask 780 scales the SNR data 442 to account for different distances from the radar system 400, 500. The SNR boost mask 780 can be a function of range and angle. In some examples, the SNR boost mask 780 scales the SNR data 442 with higher factors at longer ranges and lower factors at shorter ranges. Such scaling compensates for a range decay factor. In some examples, the SNR boost mask 780 scales the SNR data 442 with higher factors at higher angles and lower factors at lower angles. Such scaling compensates for an antenna radiation pattern. Advantageously, the SNR boost mask 780 compensates for loss of magnitude resulting from different distances.

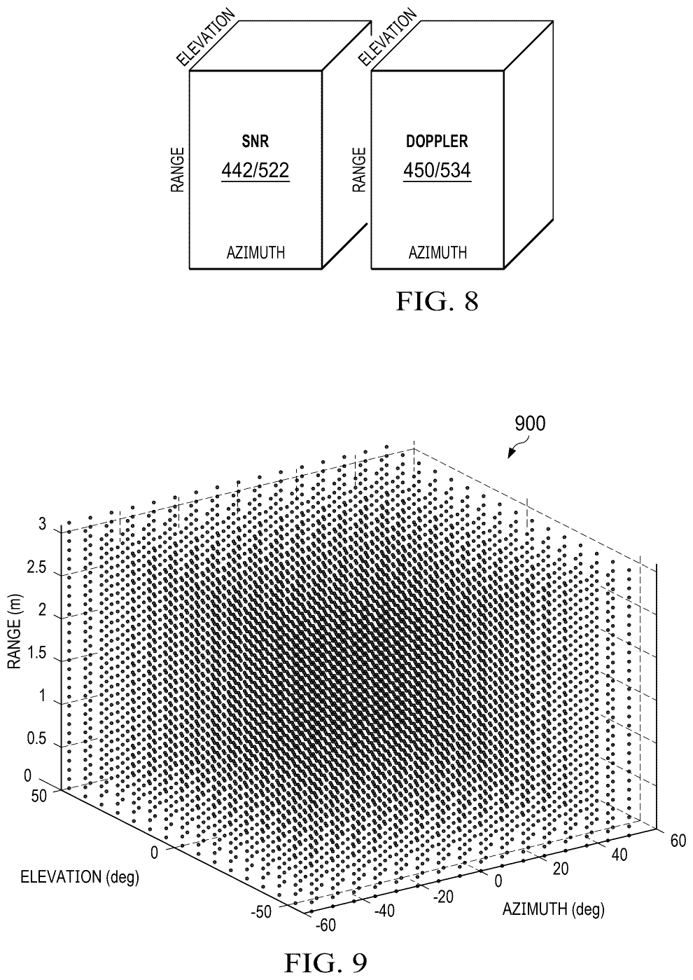

FIG. 8 are example plots illustrating an example or the radar SNR data 442 and an example of the Doppler data 450. In the example of FIG. 8, the radar SNR data 442 is an array having axes in terms of elevation, range, and azimuth. In such examples, localized values of the radar SNR data 442, which are referred to as voxels, correspond to a position relative to a radar sensor of the radar system 400, 500. Each voxel of the radar SNR data 442 identifies a signal-to-noise ratio in relation to surrounding voxels. For example, a voxel having a relatively high SNR corresponds to a relatively high amplitude signal reflection in relation to nearby voxels. Such a relatively high SNR likely indicates a direct reflection of a transmitted signal at a corresponding location.

Similarly, in the example of FIG. 8, the Doppler data 450 is an array having axes in terms of elevation, range, and azimuth. In such examples, localized values of the Doppler data 450, which are referred to as voxels, correspond to a position relative to the radar sensor of the radar system 400, 500. Each voxel of the Doppler data 450 identifies a motion across a plurality of radar frames. For example, a voxel having a relatively high Doppler value corresponds to motion of an object at a location corresponding to the voxel.

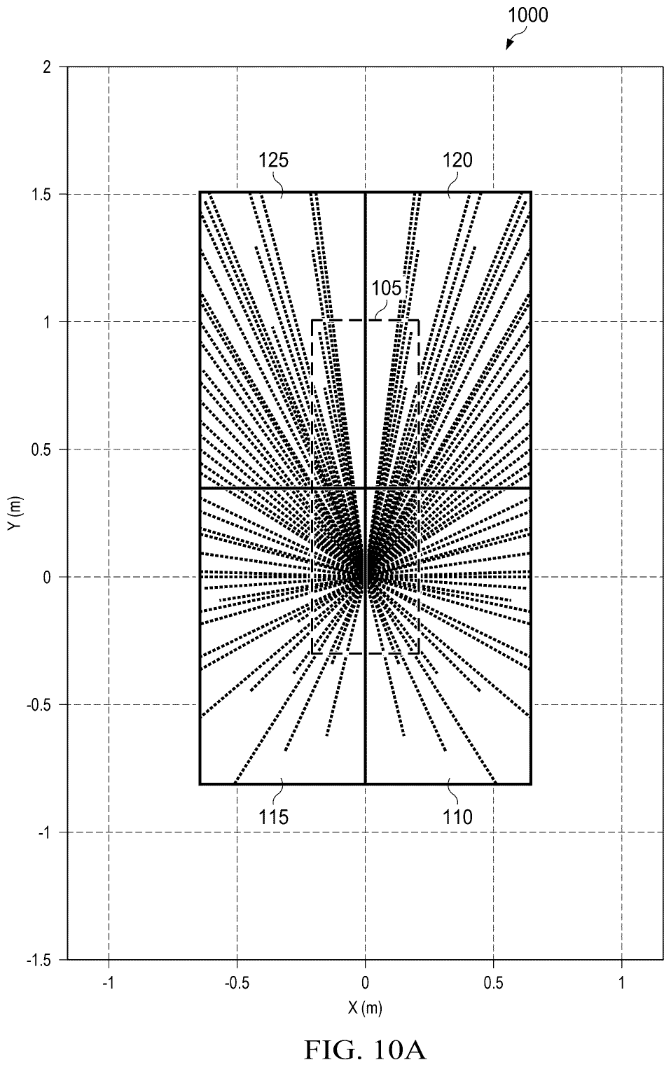

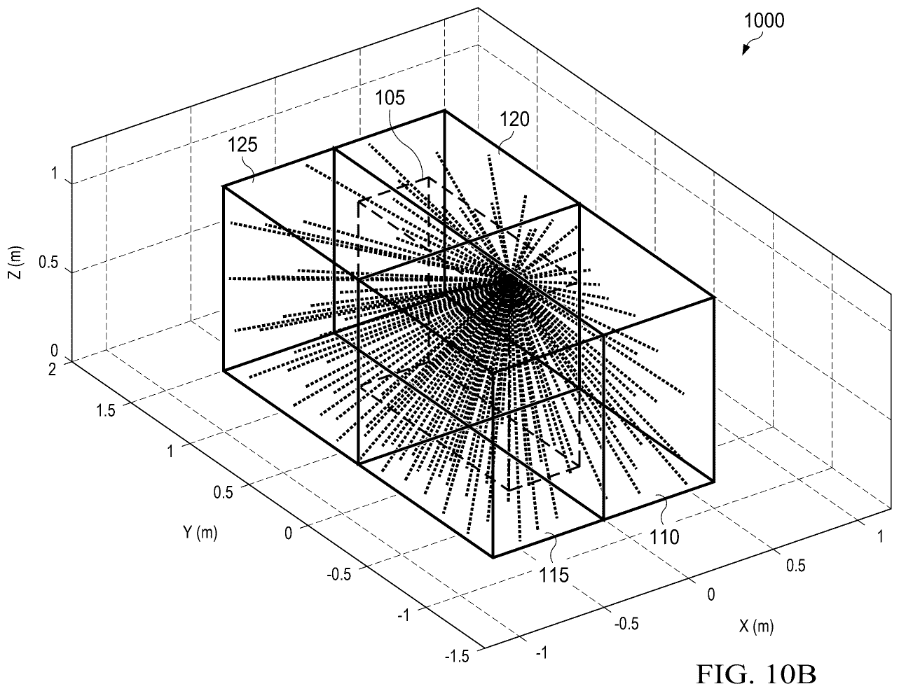

FIG. 9 is a plot of an example range-azimuth-elevation grid 900. In the example of FIG. 9, the range-azimuth-elevation grid 900 is the position of voxels of at least one of the radar SNR data 442 or the Doppler data 450 in a three-dimensional (3D) space. As illustrated in FIG. 9, the voxels of the radar SNR data 442 and the Doppler data 450 span a 3D coordinate space. In some examples, as illustrated in FIGS. 10A and 10B, the 3D coordinate space formed by the range-azimuth-elevation grid 900 can be converted to a cartesian coordinate system with voxels maintaining their SNR and/or Doppler values.

FIGS. 10A and 10B are plots of an example assignment of radar data of the radar SNR data 442 and/or the Doppler data 450 in the zones 105, 110, 115, 120, 125 of the vehicle 100 of FIGS. 1A and 1B. In the example of FIGS. 10A and 10B, an example space 1000 is formed by voxels of the radar SNR data 442 and/or the Doppler data 450 that correspond to the locations in the zones 105, 110, 115, 120, 125. For example, the voxel assignment circuitry 630 populates the space 1000 by placing data of the radar SNR data 442 and/or the Doppler data 450 into one of the zone data 635A, 635B, 635C, 635D. In such examples, the space 1000 illustrates values of the radar SNR data 442 and/or the Doppler data 450 in the zone data 635A, 635B, 635C, 635D. Advantageously, the zone data 635A, 635B, 635C, 635D accurately includes the radar SNR data 442 and/or the Doppler data 450 corresponding to each of the zones 105, 110, 115, 120, 125

FIG. 11 is a flowchart representative of example machine-readable instructions or example operations 1100 that may be at least one of executed, instantiated, or performed using an example programmable circuitry implementation of the occupancy detection circuitry 420 of FIGS. 4, 5B, and 6 or more generally the radar systems 400, 500 of FIGS. 4, 5A, and 5B. The example operations 1100 begin at Block 1105 at which the scene assignment circuitry 620 defines a reference zone. In example operations, the transform compute circuitry 615 provides a transformation matrix to the scene assignment circuitry 620. The transformation matrix is a matrix representation of a surrounding environment based on a position and orientation of a radar sensor in the vehicle 100. In such example operations, the scene assignment circuitry 620 partitions the transformation matrix to define the reference zone 105. In some examples, the scene assignment circuitry 620 determines the portion the transformation matrix corresponding to the reference zone 105 using scene boundary definitions. In other examples, the scene assignment circuitry 620 determines the position of the reference zone 105 based on the task being performed. For example, the scene assignment circuitry 620 uses the reference zone 105 for intrusion detection or occupancy detection tasks. In another example, which is further illustrated and described in FIG. 19, the scene assignment circuitry 620 may assign the driver seat as a reference zone for child detection tasks. The scene assignment circuitry 620 assigns the corresponding locations in the scene assignment matrix 625 to the reference zone 105.

The scene assignment circuitry 620 defines target zones. (Block 1110). In example operations, the scene assignment circuitry 620 further partitions the transformation matrix to define the target zones 110, 115, 120, 125. In some examples, the scene assignment circuitry 620 determines the portion of the transformation matrix corresponding to target zones 110, 115, 120, 125 using the scene boundary definitions. In other examples, the scene assignment circuitry 620 determines the position of the target zones 110, 115, 120, 125 based on the task being performed. For example, if the radar task is intrusion detection or occupancy detection, the scene assignment circuitry 620 uses the target zones 110, 115, 120, 125, which enclose portions of the vehicle 100 including doors, windows, etc. The scene assignment circuitry 620 assigns the corresponding locations in the scene assignment matrix 625 to the target zones 110, 115, 120, 125.

The SNR circuitry 416, 506 determines SNR data. (Block 1115). In example operations, the SNR circuitry 416, 506 produce the radar SNR data 442, 522. In such example operations, the radar SNR data 442, 522 are ratios of a value of a voxel to nearby voxels. For example, as illustrated in FIG. 7, the CFAR detection circuitry 444 ratios values of the voxels along the range axis. In such examples, the radar SNR data 442, 522 differentiates between reflected signals and noise.

In some examples, as illustrated by the dashed outline, the Doppler circuitry 418, 508 determines Doppler data. (Block 1120). In example operations, the Doppler circuitry 418, 508 produce the radar Doppler data 450, 534. In such example operations, the radar Doppler data 450, 534 represents a velocity of objects in the vehicle 100.

The voxel assignment circuitry 630 assigns data to the zones. (Block 1125). In example operations, the voxel assignment circuitry 630 associates the radar SNR data 442, 522 and/or the radar Doppler data 450, 534 with one of the zone data 635A, 635B, 635C, 635D using the scene assignment matrix 625. In some examples, the zone data 635A, 635B, 635C, 635D correspond to one of the zones 105, 110, 115, 120, 125. In such examples, the voxel assignment circuitry 630 uses the zone assignments of the scene assignment matrix 625 to determine a zone corresponding to each voxel of the radar SNR data 442, 522 and/or radar Doppler data 450, 534.

The reference zone circuitry 640 computes a distribution metric of the data in the reference zone. (Block 1130). In example operations, the reference zone circuitry 640 computes a mean (μ) and covariance (Σ) of the one of the zone data 635A, 635B, 635C, 635D corresponding to the reference zone 105. In other examples, the reference zone circuitry 640 may determine alternative distribution metrics, such as clusters.

The voxel difference compute circuitry 655 computes a distance metric for voxels in the target zones. (Block 1135). In example operations, the voxel difference compute circuitry 655 determines a difference metric (d) for voxels (n) in the zone data 635A, 635B, 635C, 635D corresponding to the target zones 110, 115, 120, 125. In some examples, the voxel difference compute circuitry 655 computes a Mahalanobis distance (dₙ) for each voxel of the target zones 110, 115, 120, 125 using the mean (μ) and covariance (Σ) of the reference zone 105 and the value of the voxel (yₙ). For example, the voxel difference compute circuitry 655 may use Equation (1) to determine the distance metrics of each voxel in the target zones 110, 115, 120, 125.

$${d}_{n} = ( {y}_{n} - μ ) {\sum }^{- 1} {( {y}_{n} - μ )}^{′} \qquad Equation ( 1 )$$

The zone compute circuitry 660 computes a mean of the distance metrics of the target zone(s). (Block 1140). In example operations, the zone compute circuitry 660 averages the distance metrics of the corresponding distance metrics in the zone data 635A, 635B, 635C, 635D. In such example operations, the zone compute circuitry 660 determines a zone distance metric (d_{ZONE}) as the average of the distance metrics (dₙ) of a respective one of the target zones 110, 115, 120, 125. For example, the zone compute circuitry 660 may use Equation (2) to determine the zone distance metric.

$${d}_{ZONE} = \frac{1}{N} {\sum }_{1}^{N} {d}_{n} \qquad Equation ( 2 )$$

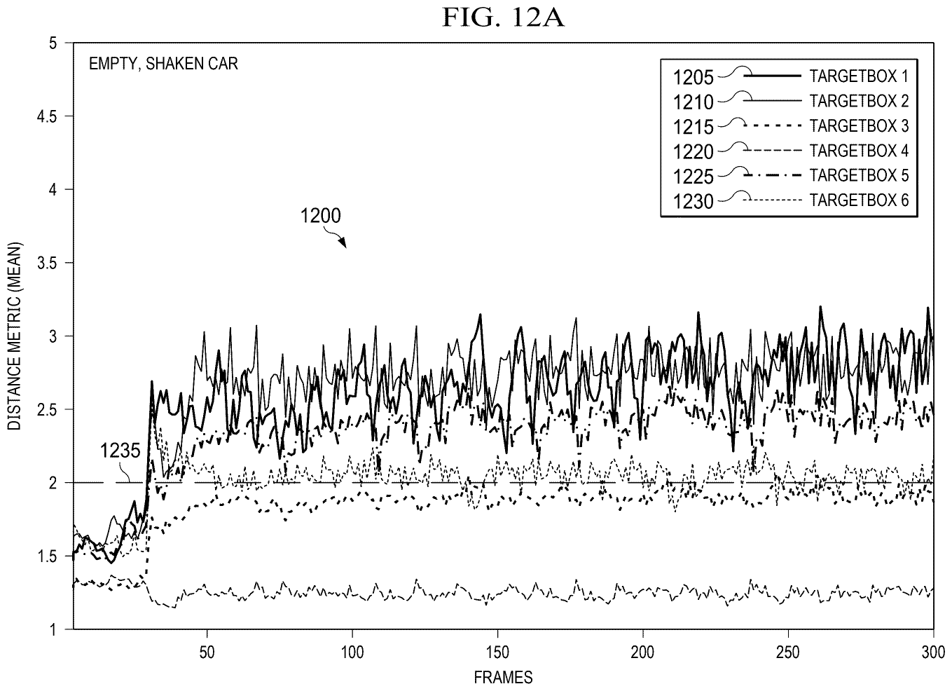

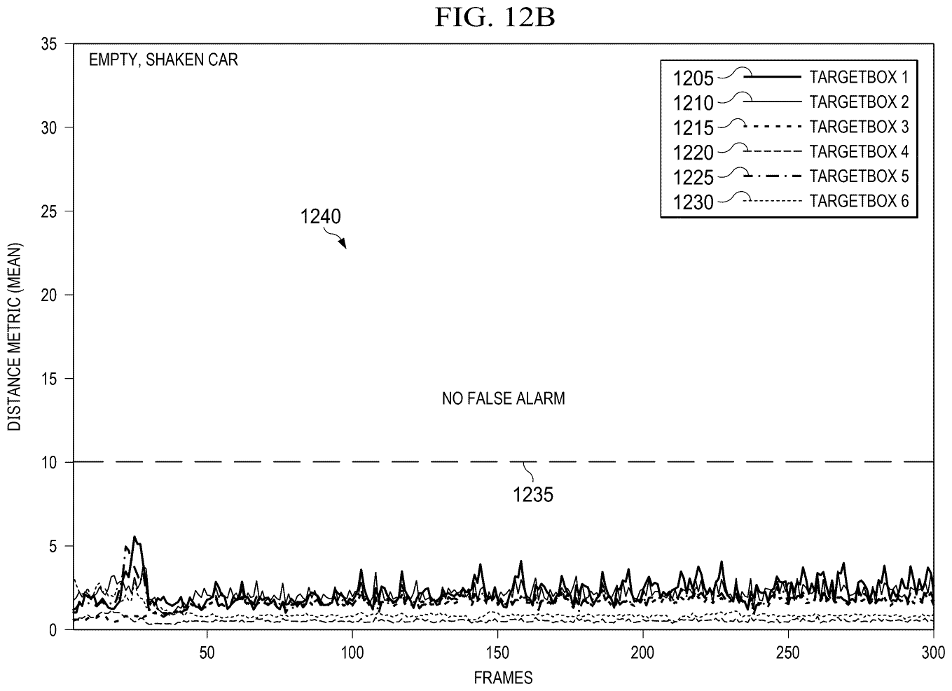

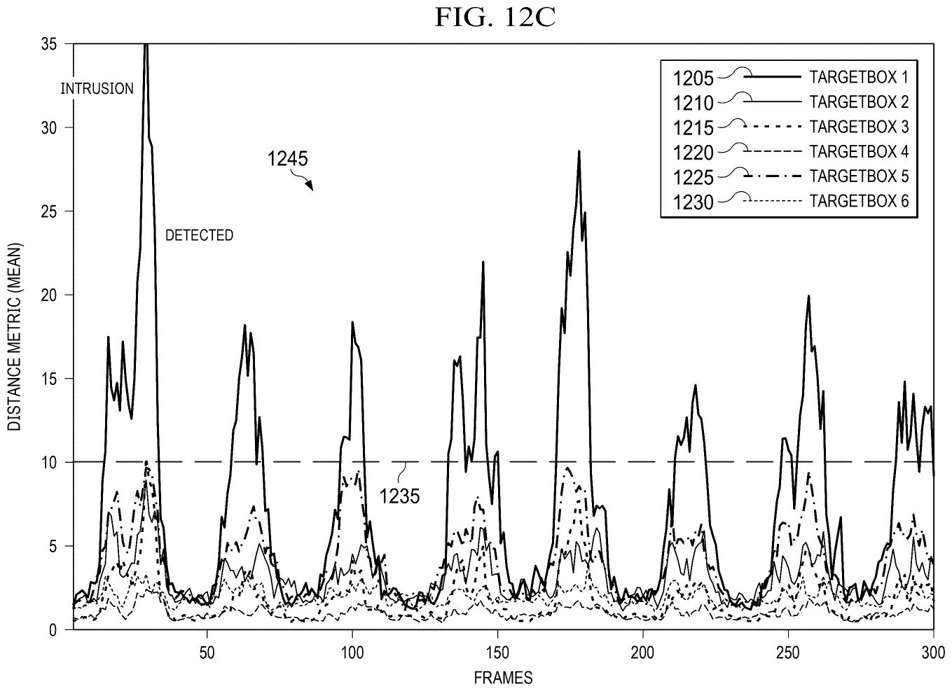

The threshold detection circuitry 665 determines a detection threshold. (Block 1145). In some examples, the threshold detection circuitry 665 receives a predetermined detection threshold. In other examples, the threshold detection circuitry 665 determines the detection threshold based on the radar task being performed. For example, the detection threshold may be higher for a radar task that is intrusion detection or occupancy detection than if the radar task is child detection. Examples of the detection threshold are further illustrated and described in connection with FIGS. 12B, 12C, 13A, 13B, 14B, 15B, 18, 20A, 20B, 20C.

The threshold detection circuitry 665 determines an occupancy. (Block 1150). In example operations, the threshold detection circuitry 665 determines occupancy in one of the target zones 110, 115, 120, 125 responsive to a determination that the zone distance metric is greater than the detection threshold. Alternatively, the threshold detection circuitry 665 determines no occupancy in the target zones 110, 115, 120, 125 if the zone distance metric is less than the detection threshold.

Control proceeds to end. Example methods are described with reference to the flowchart illustrated in FIG. 11. However, many other methods of implementing the occupancy detection circuitry 420 of FIGS. 4 and 5B or more generally the radar systems 400, 500 of FIGS. 4, 5A, and 5B may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 12A is a plot 1200 of example operations of a radar system that uses the radar SNR data 442, 522 for occupancy detection during a condition in which the vehicle 100 is being shaken. For example, a gust of wind shakes the vehicle 100. In the example of FIG. 12A, the plot 1200 includes first target zone data 1205, second target zone data 1210, third target zone data 1215, fourth target zone data 1220, fifth target zone data 1225, and sixth target zone data 1230 across a series of radar frames (e.g., the frames 402, 404). The target zone data 1205, 1210, 1215, 1220, 1225, 1230 respectively correspond to one of the target zones 310, 320, 330, 340, 350, 360 of FIGS. 3A and 3B. For example, the target zone data 1205 represents an average of the radar SNR data 442, 522 in the target zone 310 over a plurality of radar frames. Unlike the examples described in connection with FIG. 11, the average of the radar SNR data 442, 522 is considered to be a raw statistical analysis.

In the example of FIG. 12A, the plot 1200 also includes an example detection threshold 1235. The detection threshold 1235 represents an average of the radar SNR data 442, 522 that represents occupancy in the corresponding zone. For example, a radar system determines an occupant in the target zone 310 when the target zone data 1205 is greater than the detection threshold 1235. However, as illustrated in FIG. 12A, if the vehicle 100 is shaken, the target zone data 1205, 1210, 1215, 1220, 1225, 1230 increases beyond the detection threshold 1235. Such a determination of occupancy resulting from an external condition of the vehicle 100, such as being shaken by wind, is considered a false alarm.

FIG. 12B is a plot 1240 of example operations of the occupancy detection circuitry 420 of FIGS. 4, 5B, and 6 or more generally the radar system 400, 500 for occupancy detection using average zone distance metrics (d_{ZONE}) during a condition in which the vehicle 100 is being shaken. In the example of FIG. 12B, the plot 1200 includes the target zone data 1205, 1210, 1215, 1220, 1225, 1230 across a series of radar frames. Unlike in the example of FIG. 12A, in FIG. 12B, the target zone data 1205, 1210, 1215, 1220, 1225, 1230 plot the average distance metric in respective ones of the target zones 310, 320, 330, 340, 350, 360. For example, the target zone data 1205, 1210, 1215, 1220, 1225, 1230 represents a result of performing the Block 1140 of FIG. 11.

In the example of FIG. 12B, the plot 1240 also includes the detection threshold 1235. Unlike in FIG. 12A, in the example of FIG. 12B, the detection threshold 1235 corresponds to an average distance metric corresponding to an occupancy detection. For example, the threshold detection circuitry 665 determines an occupancy in the target zone 310 responsive to the target zone data 1205 being greater than the detection threshold 1235. Advantageously, as illustrated by the plot 1240, using the average distance metric of the zones 310, 320, 330, 340, 350, 360 to determine occupancy in a shaking car has less false detections in comparison to using the average value of the SNR or Doppler data, as shown in FIG. 12A.

FIG. 12C is a plot 1245 of example operations of the radar systems 400, 500 for occupancy detection a condition with a periodic intrusion in the target zone 310. The example plot 1245 includes the target zone data 1205, 1210, 1215, 1220, 1225, 1230. In example operations, an in-cabin radar sensor produces radar data having anomalous, distinct, or outlier values in the target zone 310 responsive to the example periodic intrusion. Such anomalous, distinct, or outlier values increase the average distance metric of the target zone data 1205 beyond the detection threshold 1235. In the example of FIG. 12C, the threshold detection circuitry 665 accurately detects an intrusion in the target zone 310 responsive to the average distance metric exceeding the detection threshold 1235. Similarly, the threshold detection circuitry 665 accurately detects a second intrusion event in the target zone 310 after the fiftieth frame. Advantageously, the radar systems 400, 500 accurately detect intrusion, which is a form of occupancy, in the target zone 310 without affecting other target zones.

FIG. 13A is a plot 1300 of example operations of the occupancy detection circuitry 420 or more generally the radar systems 400, 500 for occupancy detection during a condition in which the vehicle 100 is being shaken. The example plot 1300 of FIG. 13A includes an SNR only distance metric 1310 and an SNR and Doppler distance metric 1320. The SNR only distance metric 1310 represents an average distance metric of one of the target zones 310, 320, 330, 340, 350, 360 using only the radar SNR data 442, 522. The SNR and Doppler distance metric 1320 represent an average distance metric of one of the target zones 310, 320, 330, 340, 350, 360 using both the radar SNR data 442, 522 and the Doppler data 450, 534. In the example of FIG. 13A, the plot 1300 also includes a detection threshold 1330. The detection threshold 1330 is an illustrative representation of an average distance metric needed to detect an occupancy in one of the target zones 310, 320, 330, 340, 350, 360.

FIG. 13B is a plot 1340 of example operations of the occupancy detection circuitry 420 or more generally the radar systems 400, 500 for occupancy detection during a condition with a periodic intrusion in the target zone 310. The example plot 1340 of FIG. 13B includes the SNR only distance metric 1310 and the SNR and Doppler distance metric 1320. Also, the plot 1340 includes the detection threshold 1330.

In the example operations of FIGS. 13A and 13B, the differences between the distance metrics 1310, 1320 are small enough to not cause any false alarms. Also, the difference between the distance metrics 1310, 1320 are not large enough to fail in detecting an intrusion event. Advantageously, using only the radar SNR data 442, 522 simplifies the occupancy detection calculation of the radar systems 400, 500. Advantageously, using only the radar SNR data 442, 522 reduces the compute resources needed to detect occupancy in the vehicle 100. Advantageously, using both the radar SNR data 442, 522 and the Doppler data 450, 534 increases the accuracy of the occupancy detection. In some examples, such as systems with limited compute resources, the radar systems 400, 500 may use only the radar SNR data 442, 522 to determine occupancy of the vehicle 100.

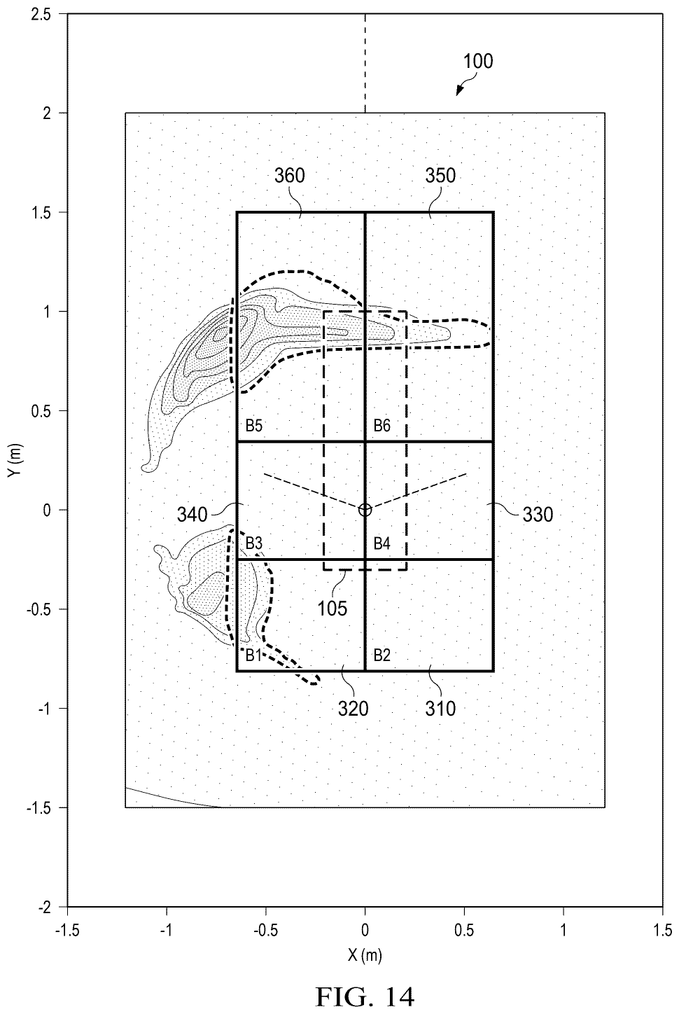

FIG. 14 illustrates operations of the radar system 400 of FIG. 4, which uses the FFT processing chain, for a condition in which an object is next to the vehicle 100. FIG. 14 illustrates the vehicle 100 and the zones 105, 310, 320, 330, 340, 350, 360 overlayed with an example of the radar SNR data 442. Unlike the radar system the radar system 500 of FIGS. 5A and 5B, which uses all data from a chirp to form the radar SNR data 522, the radar SNR data 442 only includes values for voxels having a non-zero Doppler vector. For example, the radar SNR data 442 includes SNR values for voxels that the per range circuitry 414 of FIG. 4 determines to be in motion across multiple radar frames. In example operations, without the additional SNR values of the filtered voxels, local peaks, such as the peaks corresponding to objects are more likely to produce false occupancy detections. Also, the local peaks of objects produce sidelobes by distorting reflected signals. These sidelobes further skew the average distance metric to produce additional false occupancy detections.

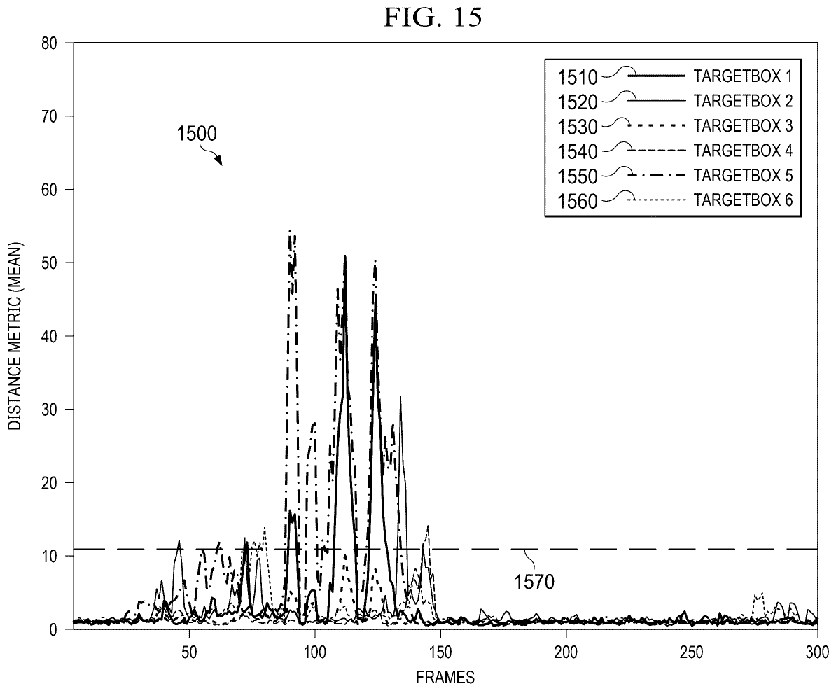

FIG. 15 is a plot 1500 of example operations of the radar system 400 for the conditions of FIG. 14. In the example of FIG. 15, the plot 1500 includes a first distance metric 1510, a second distance metric 1520, a third distance metric 1530, a fourth distance metric 1540, a fifth distance metric 1550, and a sixth distance metric 1560 across a plurality of frames (e.g., the frames 402, 404). The distance metrics 1510, 1520, 1530, 1540, 1550, 1560 illustrate the average distance metric for each of the target zones 310, 320, 330, 340, 350, 360. Also, the plot 1500 includes an example detection threshold 1570. The detection threshold 1570 is an illustrative representation of an average distance metric needed to detect and occupancy in one of the target zones 310, 320, 330, 340, 350, 360.

In the example of FIG. 15, the distance metric 1510 represents the average distance metric of the target zone 320, the distance metric 1520 represents the average distance metric of the target zone 310, the distance metric 1530 represents the average distance metric of the target zone 340, the distance metric 1540 represents the average distance metric of the target zone 330, the distance metric 1550 represents the average distance metric of the target zone 360, and the distance metric 1560 represents the average distance metric of the target zone 350. In the example of FIG. 15, the local peaks corresponding to the objects of FIG. 14 increase the average distance metric beyond the detection threshold 1570.

FIG. 16 is a block diagram of example occupancy detection circuitry 1600, which is an alternative implementation of the occupancy detection circuitry 420 of FIGS. 4, 5B, and 6, of the radar system 400 of FIGS. 4 for filtering local peaks. The occupancy detection circuitry 1600 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Also or alternatively, the occupancy detection circuitry 1600 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 16 may, thus, be instantiated at the same or different times. Some or all of the circuitry of FIG. 16 may be instantiated, for example, in one or more threads executing concurrently on hardware or in series on hardware. Moreover, in some examples, some or all of the circuitry of FIG. 16 may be implemented by microprocessor circuitry executing instructions or FPGA circuitry performing operations to implement one or more virtual machines or containers.

Unlike the occupancy detection circuitry 420, the occupancy detection circuitry 1600 includes peak filtering circuitry 1610. The peak filtering circuitry 1610 represents a series of example operations, that when performed reduce false occupancy detections in 2D FFT processing chains, such as the radar system 400. In the example of FIG. 16, the peak filtering circuitry 1610 includes example assignment check circuitry 1630, example local peak circuitry 1640, example sidelobe circuitry 1650, example peak expansion circuitry 1660, and example voxel filter circuitry 1670. In example operations, the peak filtering circuitry 1610 receives the radar SNR data 442 and the zone data 635A, 635B, 635C, 635D. In such examples, the voxel assignment circuitry 630 of FIG. 6 populates the zone data 635A, 635B, 635C, 635D using the scene assignment matrix 625 of FIG. 6. In other examples, the peak filtering circuitry 1610 may be modified to include circuitry to populate the zone data 635A, 635B, 635C, 635D using the radar SNR data 442.

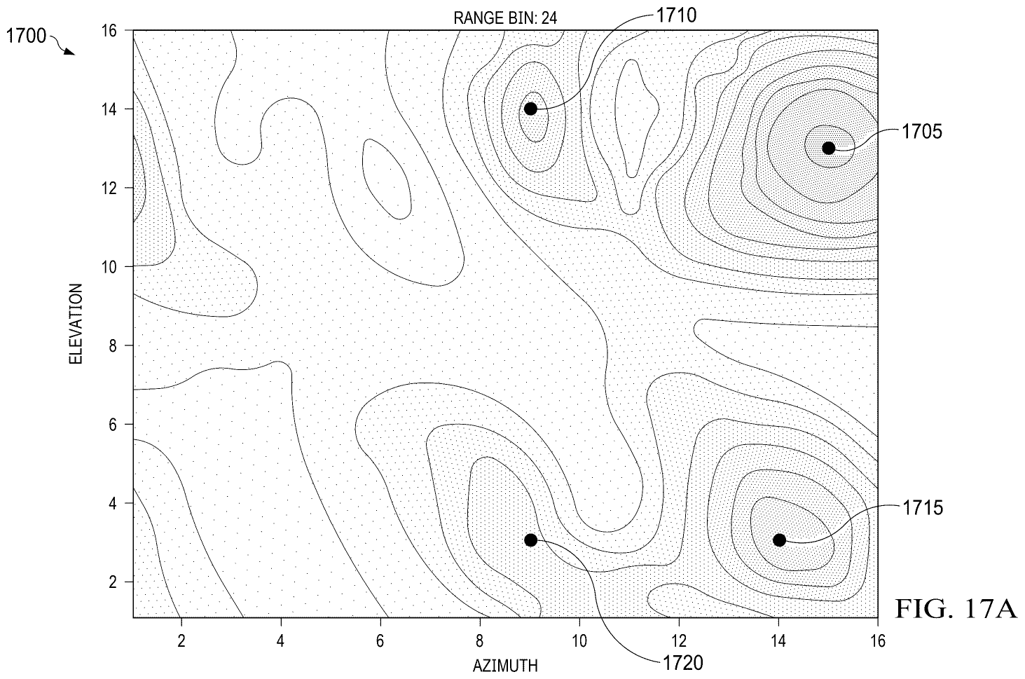

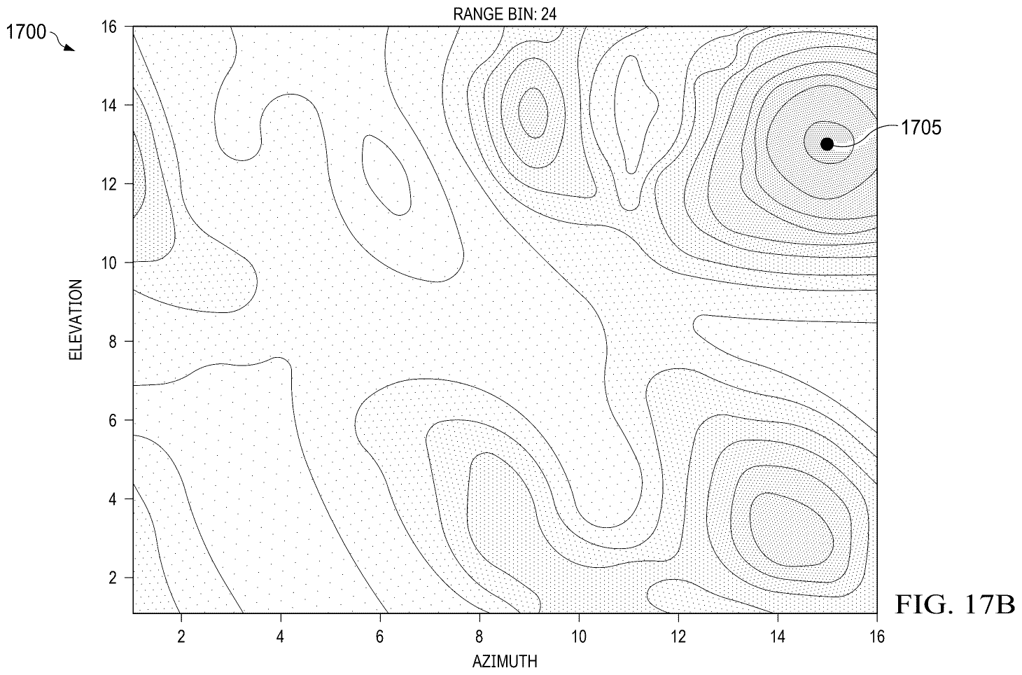

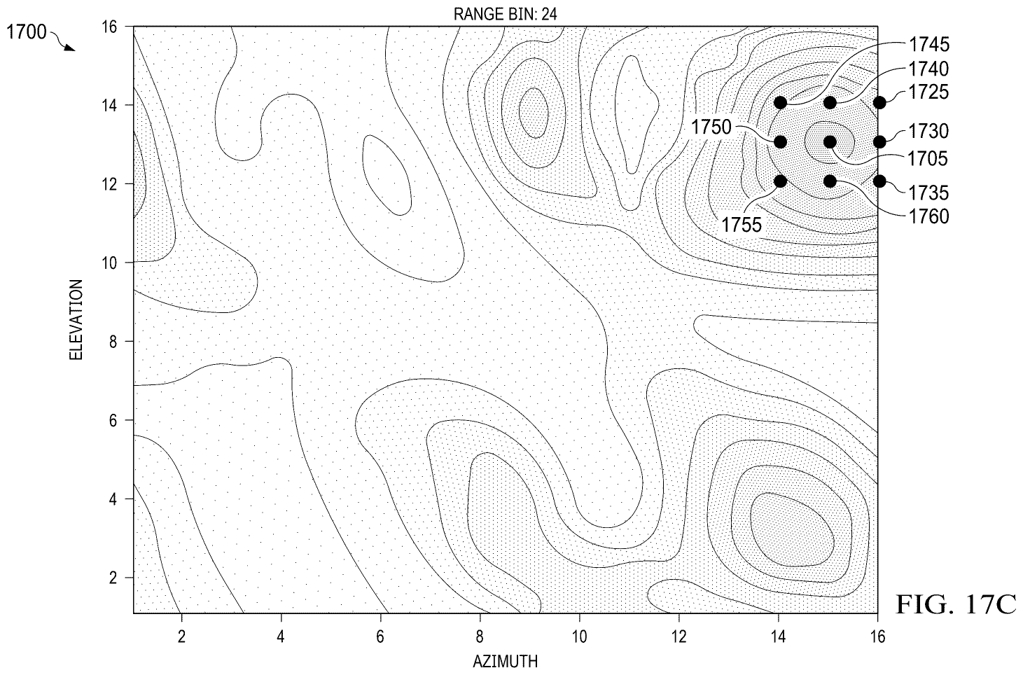

In example operations, the peak filtering circuitry 1610 processes voxels of the radar SNR data 442, which begins with the assignment check circuitry 1630 determining if a voxel is assigned to one of the zones 105, 110, 115, 120, 125 using the zone data 635A, 635B, 635C, 635D. If the assignment check circuitry 1630 determines that the voxel is not assigned to one of the zones 105, 110, 115, 120, 125 (e.g., returns a result of NO), the voxel filter circuitry 1670 ignores the voxel. In some examples, the assignment check circuitry 1630 is instantiated by programmable circuitry executing assignment check instructions to perform operations such as those represented by the plots of FIGS. 17A, 17B, and 17C.

If the assignment check circuitry 1630 determines that the voxel is assigned to one of the zones 105, 110, 115, 120, 125, the local peak circuitry 1640 determines if the voxel is a local peak. For example, the local peak circuitry 1640 may use values surrounding the voxel to determine if the voxel corresponds to a local peak. If the local peak circuitry 1640 determines that the voxel is not a local peak, the voxel filter circuitry 1670 ignores the voxel. In some examples, the local peak circuitry 1640 is instantiated by programmable circuitry executing local peak instructions to perform operations such as those represented by the plots of FIGS. 17A, 17B, and 17C.

If the local peak circuitry 1640 determines that the voxel is a local peak, the sidelobe circuitry 1650 determines if the voxel is a sidelobe. In some examples, the sidelobe circuitry 1650 compares the SNR of the voxel to a threshold value (also referred to as a sidelobe threshold). In such examples, the sidelobe circuitry 1650 determines if the voxel is a local peak of a sidelobe responsive to a comparison of the SNR to the threshold value. For example, if the SNR is less than the threshold value, the sidelobe circuitry 1650 determines that the local peak is a sidelobe, which may be caused by an angle processing artifact. If the sidelobe circuitry 1650 determines that the local peak is a sidelobe, the voxel filter circuitry 1670 ignores the voxel. In some examples, the sidelobe circuitry 1650 is instantiated by programmable circuitry executing sidelobe instructions to perform operations such as those represented by the plots of FIGS. 17A, 17B, and 17C.

If the sidelobe circuitry 1650 determines that the local peak is not a sidelobe, the peak expansion circuitry 1660 expands the local peak. In some examples, the peak expansion circuitry 1660 adds additional voxels in proximity to local peak to increase the accuracy of detection. In such examples, local peaks corresponding to an actual object are more likely to span across the additional voxels and local peaks corresponding to external noise or an object on the edge of the zones 110, 115, 120, 125 are reduced by not adding the additional voxels. In some examples, the peak expansion circuitry 1660 is instantiated by programmable circuitry executing peak expansion instructions to perform operations such as those represented by the plots of FIGS. 17A, 17B, and 17C.

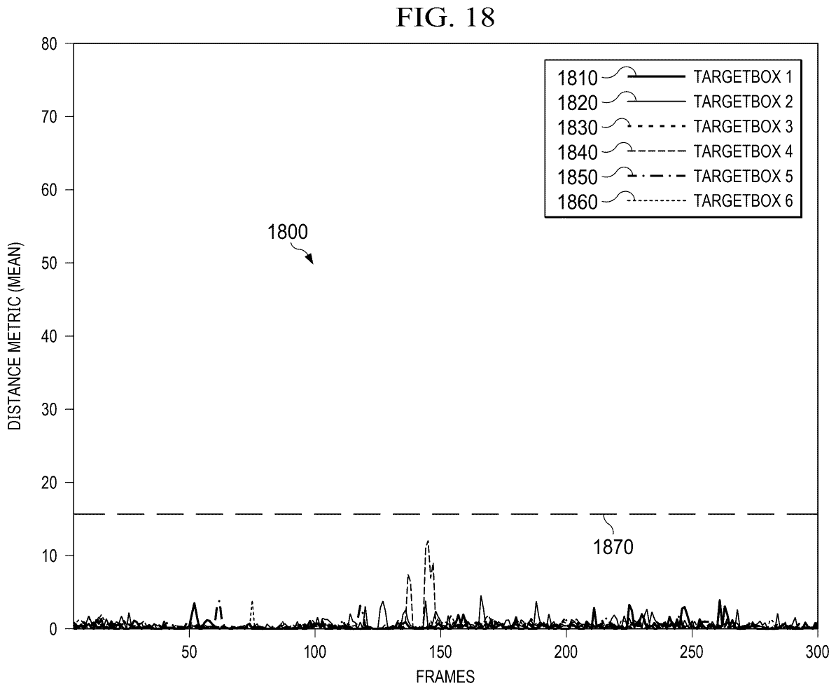

In some example operations, the voxel filter circuitry 1670 filters a voxel by removing data associated with the voxel from subsequent operations, such as determining distance metrics. In some examples, the voxel filter circuitry 1670 is instantiated by programmable circuitry executing voxel filter instructions to perform operations such as those represented by the plots of FIGS. 17A, 17B, and 17C. Example operations of the peak filtering circuitry 1610 are illustrated and described in connection with FIGS. 17A, 17B, 17C, and 18.

FIGS. 17A, 17B, and 17C are a plot 1700 of example operations of the occupancy detection circuitry 1600 to filter local peaks. The example plot 1700 of FIGS. 17A, 17B, and 17C is an illustration of an example SNR heat map including a first local peak 1705, a second local peak 1710, a third local peak 1715, and a fourth local peak 1720. In example operations of the peak filtering circuitry 1610, assuming the local peaks 1705, 1710, 1715, 1720 correspond to locations in one of the zones 310, 320, 330, 340, 350, 360, the local peak circuitry 1640 determines the voxels corresponding to the local peaks 1705, 1710, 1715, 1720.

In example operations of FIG. 17B, the sidelobe circuitry 1650 compares the SNR values of the voxels at the local peaks 1705, 1710, 1715, 1720 to a sidelobe threshold. In the example of FIG. 17B, the sidelobe circuitry 1650 determines that SNR value of the local peaks 1710, 1715, 1720 are less than the sidelobe threshold. In such examples, the voxel filter circuitry ignores the voxels at the local peaks 1710, 1715, 1720. Advantageously, the sidelobe circuitry 1650 reduces false alarms by filtering local peaks that are sidelobes of an object.

In example operations of FIG. 17C, the peak expansion circuitry 1660 determines values of a first expanded voxel 1725, a second expanded voxel 1730, a third expanded voxel 1735, a fourth expanded voxel 1740, a fifth expanded voxel 1745, a sixth expanded voxel 1750, a seventh expanded voxel 1755, and an eighth expanded voxel 1760. In such example operations, the expanded voxels 1725, 1730, 1735, 1740, 1745, 1750, 1755, 1760 bias the average distance metric to reduce false alarms and increase zone detection accuracy. Example results using the operations of FIGS. 17A, 17B, and 17C are illustrated and described in connection with FIG. 18.

FIGS. 18 is a plot 1800 of example operations of the radar system 400 of FIG. 4 with the occupancy detection circuitry 1600 of FIG. 16 filtering local peaks. In the example of FIG. 18, the plot 1800 includes a first distance metric 1810, a second distance metric 1820, a third distance metric 1830, a fourth distance metric 1840, a fifth distance metric 1850, and a sixth distance metric 1860 across a plurality of frames (e.g., the frames 402, 404). The distance metrics 1810, 1820, 1830, 1840, 1850, 1860 illustrate the average distance metric for each of the target zones 310, 320, 330, 340, 350, 360. Also, the plot 1800 includes an example detection threshold 1570. The detection threshold 1870 is an illustrative representation of an average distance metric needed to detect and occupancy in one of the target zones 310, 320, 330, 340, 350, 360.

Unlike in the example of FIG. 15, where sidelobes of the objects produced false occupancy detections. In the example of FIG. 18, the peak filtering circuitry 1610 of FIG. 16 filters local peaks and expands peaks corresponding to objects. Advantageously, the peak filtering circuitry 1610 reduces false occupancy detections.

FIG. 19 is a block diagram of an example of the vehicle 100 having a reference zone 1910, a first target zone 1920, a second target zone 1930, a fourth target zone 1940, and a fifth target zone 1950. Unlike in the examples of FIGS. 1A, 1B, 3A, and 3B, where the reference zone 105 is centrally located, the reference zone 1910 is located in a region that a child is not expected to be. For example, an infant or small child is highly unlikely to sit in the driver's seat of the vehicle 100. In such examples, positioning the reference zone 1910 to enclose the driver allows the radar systems 400, 500 to detect occupancy by a passenger if a driver is not present. Such detection reduces the likelihood of leaving a passenger, such as a child, in the vehicle 100. Also, locating the zones 1910, 1920, 1930, 1940, 1950 as illustrated in FIG. 19 improves a likelihood of detection.

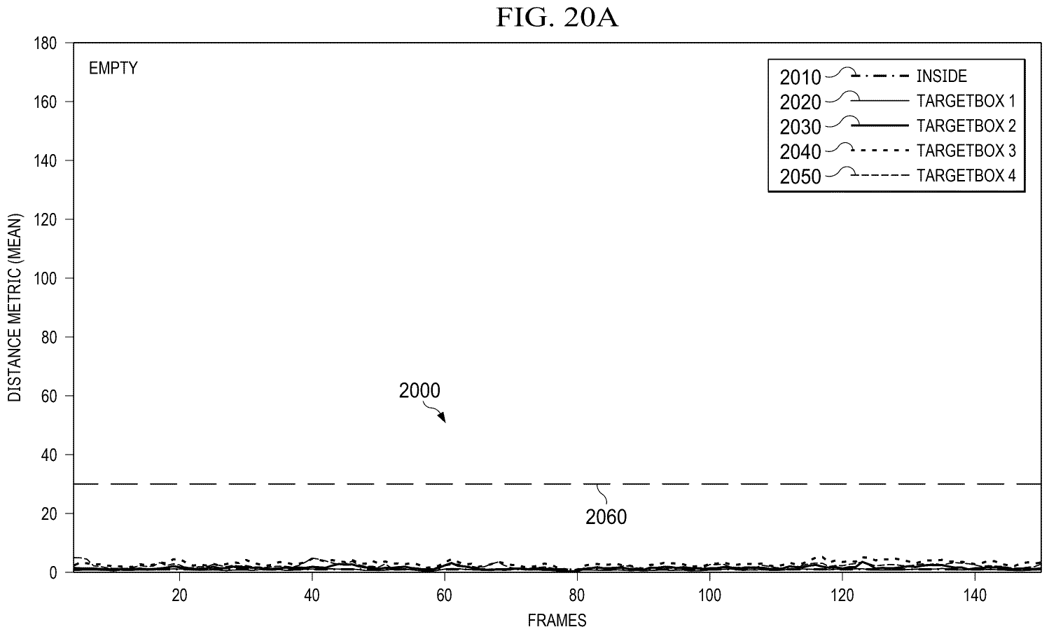

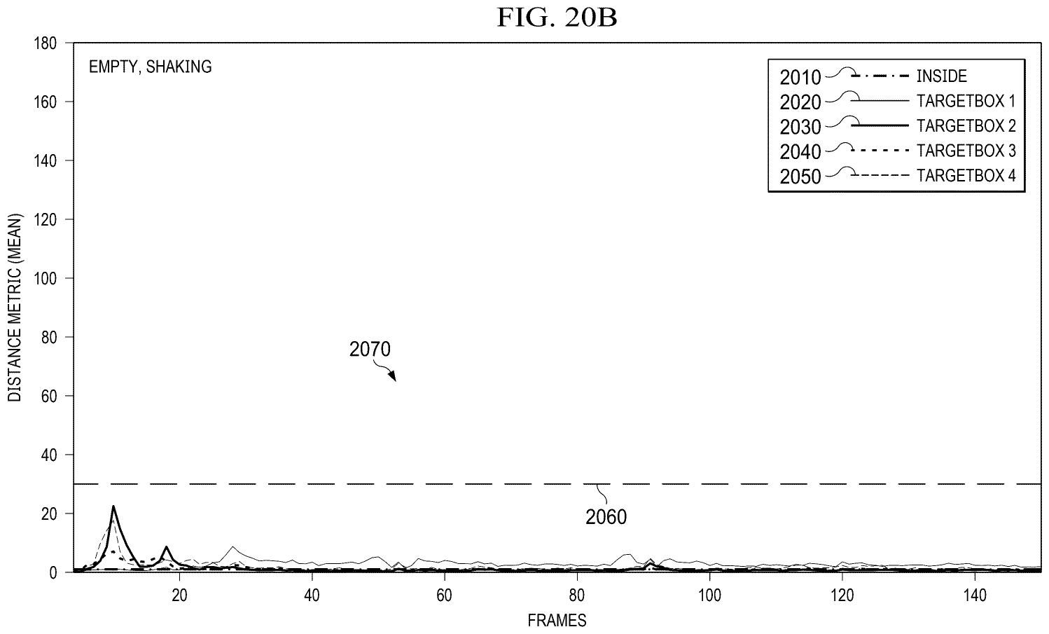

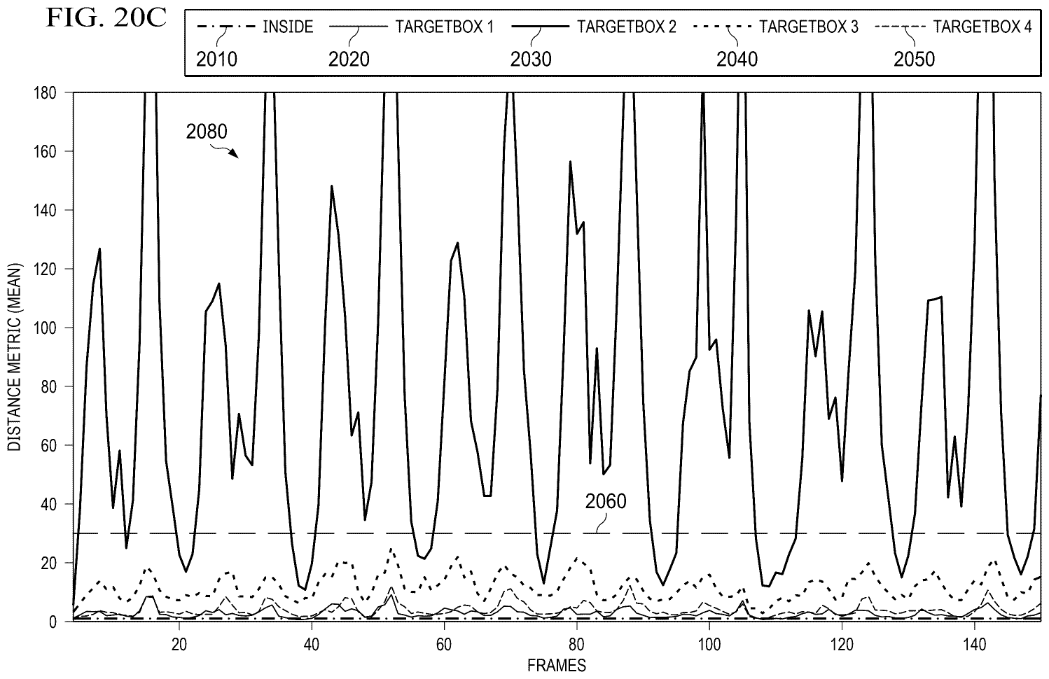

FIG. 20A is a plot 2000 of example operations of the radar systems 400, 500 during the condition in which there is no occupancy in the zones 1910, 1920, 1930, 1940, 1950 of FIG. 19. In the example of FIG. 20A, the plot 2000 illustrates a first zone distance metric 2010, a second zone distance metric 2020, a third zone distance metric 2030, a fourth zone distance metric 2040, and a fifth zone distance metric 2050 across a plurality of radar frames (e.g., the frames 402, 404). The zone distance metrics 2010, 2020, 2030, 2040, 2050 illustrate the average distance metric for each of the zones 1910, 1920, 1930, 1940, 1950. For example, the zone distance metric 2010 represents the average distance metric of the reference zone 1910, the zone distance metric 2020 represents the average distance metric of the target zone 1920, etc. Also, the plot 2000 includes an example detection threshold 2060. The detection threshold 2060 is an illustrative representation of an average distance metric needed to detect and occupancy in one of the target zones 1920, 1930, 1940, 1950. In the example of FIG. 20A, the zone distance metrics 2010, 2020, 2030, 2040, 2050 remain less than the detection threshold 2060. Advantageously, the radar systems 400, 500 accurately determine no occupancy in the zones 1910, 1920, 1930, 1940, 1950 during the operations of FIG. 20A.

FIG. 20B is a plot 2070 of example operations of the radar systems 400, 500 during the conditions in which there is no occupancy and the vehicle 100 is shaking. In the example of FIG. 20B, the plot 2070 illustrates the zone distance metrics 2010, 2020, 2030, 2040, 2050 across a plurality of frames for the conditions of FIG. 20B. In the example of FIG. 20B, the zone distance metrics 2010, 2020, 2030, 2040, 2050 remain less than the detection threshold 2060. Advantageously, the radar systems 400, 500 accurately determine no occupancy in the zones 1910, 1920, 1930, 1940, 1950 during the operations of FIG. 20B. Advantageously, the zone distance metrics 2010, 2020, 2030, 2040, 2050 remain less than the detection threshold 2060 despite external factors shaking the vehicle 100.

FIG. 20C is a plot 2080 of example operations of the radar systems 400, 500 during the conditions where there is occupancy by a child in a footwell of the target zone 1930. In the example of FIG. 20C, the plot 2080 illustrates the zone distance metrics 2010, 2020, 2030, 2040, 2050 across a plurality of frames for the conditions of FIG. 20C. In the example of FIG. 20C, the zone distance metric 2030 exceeds the detection threshold 2060 to indicate occupancy in the target zone 1930. Advantageously, the radar systems 400, 500 can accurately detect occupancy in a footwell of the zones 1910, 1920, 1930, 1940, 1950 during the operations of FIG. 20C. Advantageously, the zone distance metrics 2010, 2020, 2040, 2050 remain less than the detection threshold 2060 to accurately reflect occupancy only in the target zone 1930.

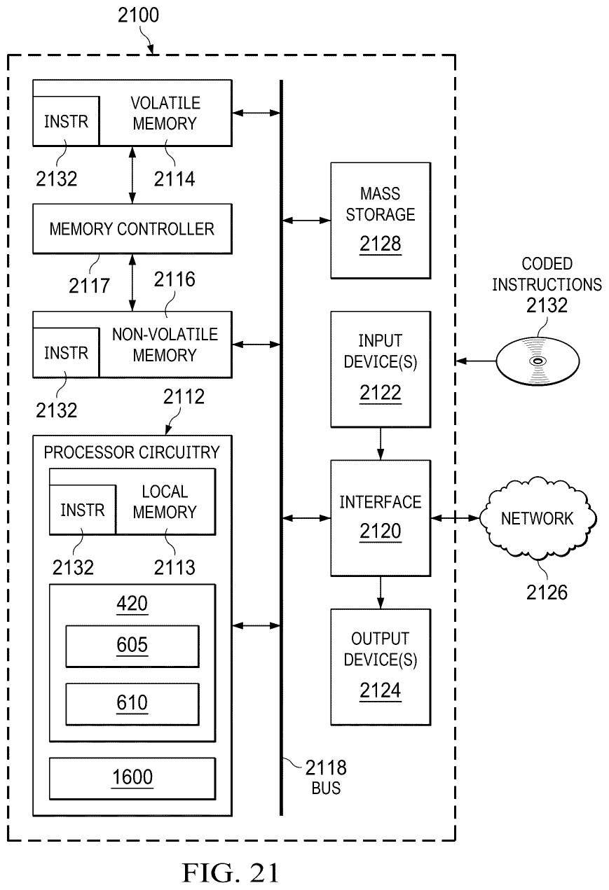

FIG. 21 is a block diagram of an example programmable circuitry platform 2100 structured to one or a combination of execute or instantiate one or more of the example machine-readable instructions or the example operations of FIG. 11 to implement the occupancy detection circuitry 420, 1600 of FIGS. 4, 5A, 5B, 6, and 16. The programmable circuitry platform 2100 can be, for example, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a set top box, or any other type of computing or electronic device.

The programmable circuitry platform 2100 of the illustrated example includes programmable circuitry 2112. The programmable circuitry 2112 of the illustrated example is hardware. For example, the programmable circuitry 2112 can be implemented by one or more integrated circuits, logic circuits, FPGAs, microprocessors, CPUs, GPUs, DSPs, or microcontrollers from any desired family or manufacturer. The programmable circuitry 2112 may be implemented by one or more semiconductor based (e.g., silicon based) devices. In this example, the programmable circuitry 2112 implements the occupancy detection circuitry 420, 1600 of FIGS. 4, 5A, 5B, 6, and 16.

The programmable circuitry 2112 of the illustrated example includes a local memory 2113 (e.g., a cache, registers, etc.). The programmable circuitry 2112 of the illustrated example is in communication with main memory 2114, 2116, which includes a volatile memory 2114 and a non-volatile memory 2116, by a bus 2118. The volatile memory 2114 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 2116 may be implemented by one or a combination of flash memory or any other desired type of memory device. Access to the main memory 2114, 2116 of the illustrated example is controlled by a memory controller 2117. In some examples, the memory controller 2117 may be implemented by one or more integrated circuits, logic circuits, microcontrollers from any desired family or manufacturer, or any other type of circuitry to manage the flow of data going to and from the main memory 2114, 2116.

The programmable circuitry platform 2100 of the illustrated example also includes interface circuitry 2120. The interface circuitry 2120 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 2122 are connected to the interface circuitry 2120. The input device(s) 2122 permit(s) a user (e.g., a human user, a machine user, etc.) to enter one of or a combination of data or commands into the programmable circuitry 2112. The input device(s) 2122 can be implemented by, for example, one of or a combination of a radar system (e.g., the radar systems 400, 500), a radar sensor, an audio sensor, a microphone, a camera (still or video), a keyboard, a button, a mouse, a touchscreen, a trackpad, a trackball, an isopoint device, or a voice recognition system.

One or more output devices 2124 are also connected to the interface circuitry 2120 of the illustrated example. The output device(s) 2124 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 2120 of the illustrated example, thus, includes one of or a combination of a graphics driver card, a graphics driver chip, or graphics processor circuitry such as a GPU.

The interface circuitry 2120 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2100 of the illustrated example also includes one or more mass storage discs or devices 2128 to store one or more of firmware, software, or data. Examples of such mass storage discs or devices 2128 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 2132, which may be implemented by the machine-readable instructions of FIG. 11, may be stored in one of or a combination of the mass storage device 2128, in the volatile memory 2114, in the non-volatile memory 2116, or on at least one non-transitory computer readable storage medium such as a CD or DVD which may be removable.

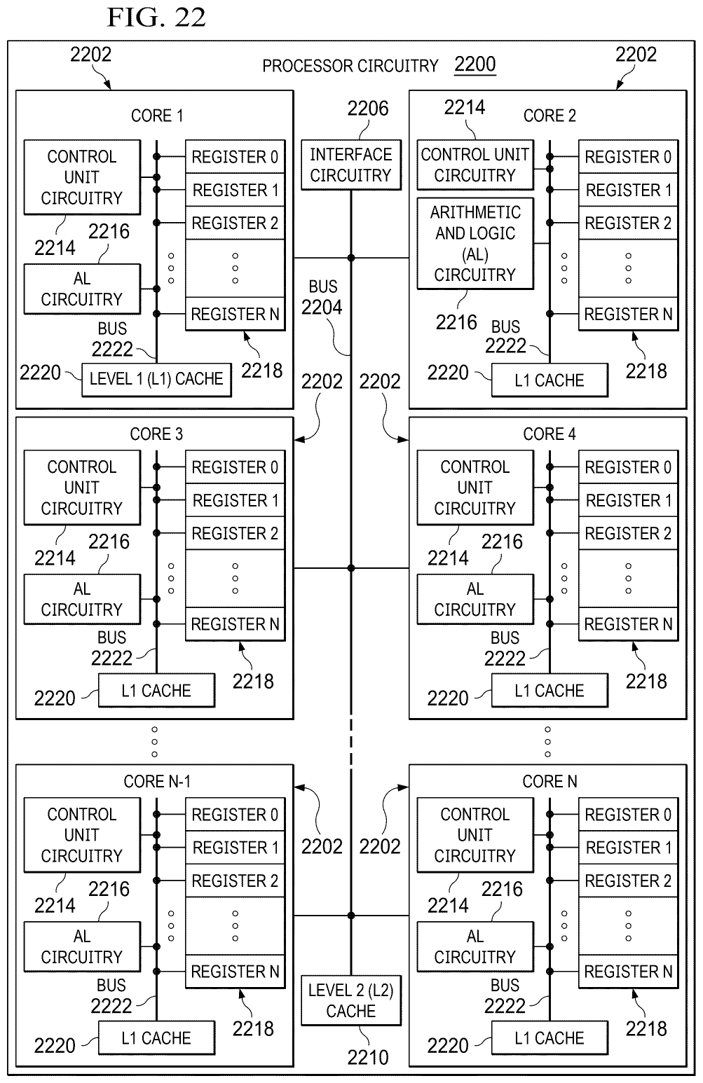

FIG. 22 is a block diagram of an example implementation of the programmable circuitry 2112 of FIG. 21. In this example, the programmable circuitry 2112 of FIG. 21 is implemented by a microprocessor 2200. For example, the microprocessor 2200 may be a general-purpose microprocessor (e.g., general-purpose microprocessor circuitry). The microprocessor 2200 executes some or all of the machine-readable instructions of the flowchart of FIG. 11 to effectively instantiate the circuitry of FIG. 2 as logic circuits to perform operations corresponding to those machine-readable instructions. In some such examples, the circuitry of FIG. [ER-Diagram] is instantiated by the hardware circuits of the microprocessor 2200 in combination with the machine-readable instructions. For example, the microprocessor 2200 may be implemented by multi-core hardware circuitry such as a CPU, a DSP, a GPU, an XPU, etc. Although it may include any number of example cores 2202 (e.g., 1 core), the microprocessor 2200 of this example is a multi-core semiconductor device including N cores. The cores 2202 of the microprocessor 2200 may operate independently or may cooperate to execute machine-readable instructions. For example, machine code corresponding to a firmware program, an embedded software program, or a software program may be executed by one of the cores 2202 or may be executed by multiple ones of the cores 2202 at the same or different times. In some examples, the machine code corresponding to the firmware program, the embedded software program, or the software program is split into threads and executed in parallel by two or more of the cores 2202. The software program may correspond to a portion or all of the machine-readable instructions or operations represented by the flowchart of FIG. 11.

The cores 2202 may communicate by a first example bus 2204. In some examples, the first bus 2204 may be implemented by a communication bus to effectuate communication associated with one(s) of the cores 2202. For example, the first bus 2204 may be implemented by at least one of an Inter-Integrated Circuit (I2C) bus, a Serial Peripheral Interface (SPI) bus, a PCI bus, or a PCIe bus. Also or alternatively, the first bus 2204 may be implemented by any other type of computing or electrical bus. The cores 2202 may receive data, instructions, and signals from one or more external devices by example interface circuitry 2206. The cores 2202 may output data, instructions, and signals to the one or more external devices by the interface circuitry 2206. Although the cores 2202 of this example include example local memory 2220 (e.g., Level 1 (L1) cache that may be split into an L1 data cache and an L1 instruction cache), the microprocessor 2200 also includes example shared memory 2210 that may be shared by the cores (e.g., Level 2 (L2 cache)) for high-speed access to data and instructions. Data and instructions may be transferred (e.g., shared) by one of or a combination of writing to or reading from the shared memory 2210. The local memory 2220 of each of the cores 2202 and the shared memory 2210 may be part of a hierarchy of storage devices including multiple levels of cache memory and the main memory (e.g., the main memory 2114, 2116 of FIG. 21). Higher levels of memory in the hierarchy exhibit lower access time and have smaller storage capacity than lower levels of memory. Changes in the various levels of the cache hierarchy are managed (e.g., coordinated) by a cache coherency policy.

Each core 2202 may be referred to as a CPU, DSP, GPU, etc., or any other type of hardware circuitry. Each core 2202 includes control unit circuitry 2214, arithmetic and logic (AL) circuitry (sometimes referred to as an ALU) 2216, a plurality of registers 2218, the local memory 2220, and a second example bus 2222. Other structures may be present. For example, each core 2202 may include vector unit circuitry, single instruction multiple data (SIMD) unit circuitry, load/store unit (LSU) circuitry, branch/jump unit circuitry, floating-point unit (FPU) circuitry, etc. The control unit circuitry 2214 includes semiconductor-based circuits structured to control (e.g., coordinate) data movement within the corresponding core 2202. The AL circuitry 2216 includes semiconductor-based circuits structured to perform one or more mathematic or logic operations on the data within the corresponding core 2202. The AL circuitry 2216 of some examples performs integer-based operations. In other examples, the AL circuitry 2216 also performs floating-point operations. In yet other examples, the AL circuitry 2216 may include first AL circuitry that performs integer-based operations and second AL circuitry that performs floating-point operations. In some examples, the AL circuitry 2216 may be referred to as an Arithmetic Logic Unit (ALU).

The registers 2218 are semiconductor-based structures to store data and instructions such as results of one or more of the operations performed by the AL circuitry 2216 of the corresponding core 2202. For example, the registers 2218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2218 may be arranged in a bank as shown in FIG. 22. Alternatively, the registers 2218 may be organized in any other arrangement, format, or structure, such as by being distributed throughout the core 2202 to shorten access time. The second bus 2222 may be implemented by at least one of an I2C bus, a SPI bus, a PCI bus, or a PCIe bus.

Each core 2202 or, more generally, the microprocessor 2200 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 2200 is a semiconductor device fabricated to include many transistors interconnected to implement the structures described above in one or more integrated circuits (ICs) contained in one or more packages.

The microprocessor 2200 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those described herein. A GPU, DSP, or other programmable device can also be an accelerator. Accelerators may be on board the microprocessor 2200, in the same chip package as the microprocessor 2200, or in one or more separate packages from the microprocessor 2200.

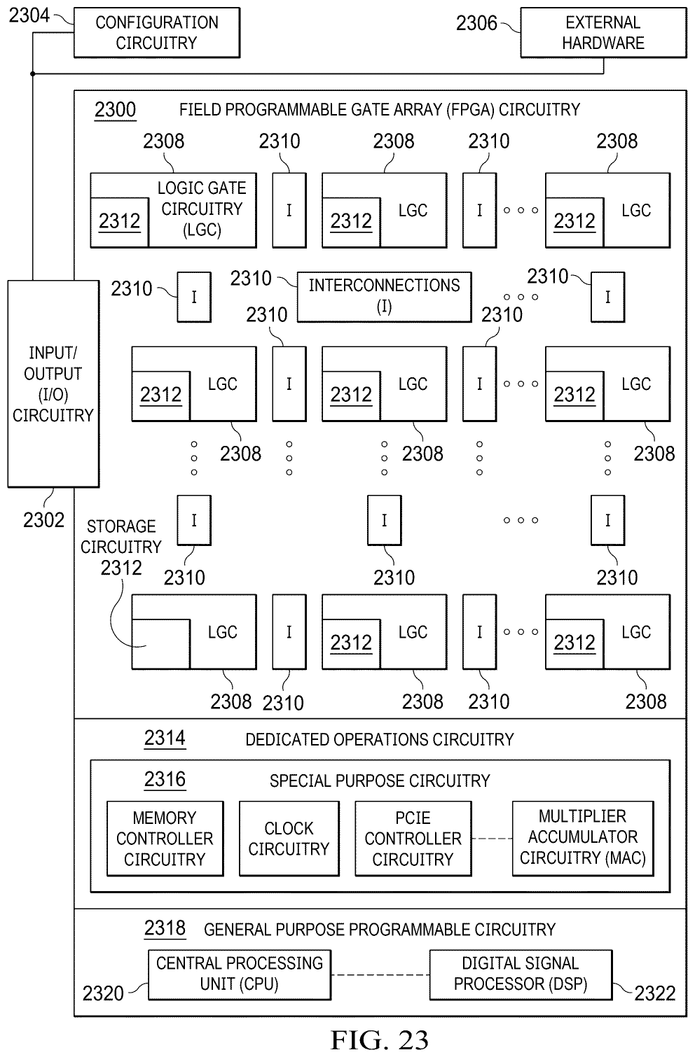

FIG. 23 is a block diagram of another example implementation of the programmable circuitry 2112 of FIG. 21. In this example, the programmable circuitry 2112 is implemented by FPGA circuitry 2300. For example, the FPGA circuitry 2300 may be implemented by an FPGA. The FPGA circuitry 2300 can be used, for example, to perform operations that could otherwise be performed by the example microprocessor 2200 of FIG. 22 executing corresponding machine-readable instructions. However, once configured, the FPGA circuitry 2300 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 2200 of FIG. 22 described above (which is a general purpose device that may be programmed to execute some or all of the machine-readable instructions represented by the flowchart of FIG. 11 but whose interconnections and logic circuitry are fixed once fabricated), the FPGA circuitry 2300 of the example of FIG. 23 includes interconnections and logic circuitry that may be one of or a combination of configured, structured, programmed, and interconnected in different ways after fabrication to instantiate, for example, some or all of the operations/functions corresponding to the machine-readable instructions represented by the flowchart of FIG. 11. In particular, the FPGA circuitry 2300 may be thought of as an array of logic gates, interconnections, and switches. The switches can be programmed to change how the logic gates are interconnected by the interconnections, effectively forming one or more dedicated logic circuits (unless and until the FPGA circuitry 2300 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 11. As such, the FPGA circuitry 2300 may be at least one of configured or structured to effectively instantiate some or all of the operations/functions corresponding to the machine-readable instructions of the flowchart of FIG. 11 as dedicated logic circuits to perform the operations/functions corresponding to those software instructions in a dedicated manner analogous to an ASIC. Therefore, the FPGA circuitry 2300 may perform the operations/functions corresponding to the some or all of the machine-readable instructions of FIG. 11 faster than the general-purpose microprocessor can execute the same.

In the example of FIG. 23, the FPGA circuitry 2300 is at least one of configured or structured in response to being programmed (and/or reprogrammed one or more times) based on a binary file. In some examples, the binary file may be one of or both of compiled or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2300 of FIG. 23 may at least one of access or load the binary file to cause the FPGA circuitry 2300 of FIG. 23 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 2300 of FIG. 23 to at least one of configure or structure the FPGA circuitry 2300 of FIG. 23, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 2300 of FIG. 23 may at least one of access or load the binary file to cause the FPGA circuitry 2300 of FIG. 23 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 2300 of FIG. 23 to at least one of configure or structure the FPGA circuitry 2300 of FIG. 23, or portion(s) thereof.

The FPGA circuitry 2300 of FIG. 23, includes example input/output (I/O) circuitry 2302 to at least one of produce or output data to/from at least one of example configuration circuitry 2304 or external hardware 2306. For example, the configuration circuitry 2304 may be implemented by interface circuitry that may receive a binary file, which may be implemented by one or more of a bit stream, data, or machine-readable instructions, to configure the FPGA circuitry 2300, or portion(s) thereof. In some such examples, the configuration circuitry 2304 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 2306 may be implemented by external hardware circuitry. For example, the external hardware 2306 may be implemented by the microprocessor 2200 of FIG. 22.

The FPGA circuitry 2300 also includes an array of example logic gate circuitry 2308, a plurality of example configurable interconnections 2310, and example storage circuitry 2312. The logic gate circuitry 2308 and the configurable interconnections 2310 are configurable to instantiate one or more operations/functions that may correspond to at least some of the machine-readable instructions of FIGS. [Flowcharts] and/or other desired operations. The logic gate circuitry 2308 shown in FIG. 23 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2308 to enable configuration of one of or a combination of the electrical structures or the logic gates to form circuits to perform desired operations/functions. The logic gate circuitry 2308 may include other electrical structures such as look-up tables (LUTs), registers (e.g., flip-flops or latches), multiplexers, etc.

The configurable interconnections 2310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2308 to program desired logic circuits.

The storage circuitry 2312 of the illustrated example is structured to store result(s) of the one or more of the operations performed by corresponding logic gates. The storage circuitry 2312 may be implemented by registers or the like. In the illustrated example, the storage circuitry 2312 is distributed amongst the logic gate circuitry 2308 to facilitate access and increase execution speed.

The example FPGA circuitry 2300 of FIG. 23 also includes example dedicated operations circuitry 2314. In this example, the dedicated operations circuitry 2314 includes special purpose circuitry 2316 that may be invoked to implement commonly used functions to avoid the need to program those functions in the field. Examples of such special purpose circuitry 2316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2300 may also include example general purpose programmable circuitry 2318 such as an example CPU 2320 or an example DSP 2322. Other general purpose programmable circuitry 2318 may also or alternatively be present such as a GPU, an XPU, etc., that can be programmed to perform other operations.

Although FIGS. 22 and 23 illustrate two example implementations of the programmable circuitry 2112 of FIG. 21, many other approaches are contemplated. For example, FPGA circuitry may include an on board CPU, such as one or more of the example CPU 2320 of FIG. 22. Therefore, the programmable circuitry 2112 of FIG. 21 may also be implemented by combining at least the example microprocessor 2200 of FIG. 22 and the example FPGA circuitry 2300 of FIG. 23. In some such hybrid examples, one or more cores 2202 of FIG. 22 may execute a first portion of the machine-readable instructions represented by the flowchart of FIG. 11 to perform first operation(s)/function(s), the FPGA circuitry 2300 of FIG. 23 may be at least one of configured or structured to perform second operation(s)/function(s) corresponding to a second portion of the machine-readable instructions represented by the flowchart of FIG. 11, and/or an ASIC may be at least one of configured or structured to perform third operation(s)/function(s) corresponding to a third portion of the machine-readable instructions represented by the flowchart of FIG. 11.

Some or all of the circuitry of FIGS. 6 and 16 may, thus, be instantiated at the same or different times. For example, same and/or different portion(s) of the microprocessor 2200 of FIG. 22 may be programmed to execute portion(s) of machine-readable instructions at the same and/or different times. In some examples, same and/or different portion(s) of the FPGA circuitry 2300 of FIG. 23 may be at least one of configured or structured to perform operations/functions corresponding to portion(s) of machine-readable instructions at the same and/or different times.

In some examples, some or all of the circuitry of FIGS. 6 and 16 may be instantiated, for example, in one or more threads executing concurrently and/or in series. For example, the microprocessor 2200 of FIG. 22 may execute machine-readable instructions in one or more threads executing concurrently and/or in series. In some examples, the FPGA circuitry 2300 of FIG. 23 may be at least one of configured or structured to carry out operations/functions concurrently and/or in series. Moreover, in some examples, some or all of the circuitry of FIGS. 6 and 16 may be implemented within one or more virtual machines or containers executing on the microprocessor 2200 of FIG. 22.

In some examples, the programmable circuitry 2112 of FIG. 21 may be in one or more packages. For example, at least one of the microprocessor 2200 of FIG. 22 or the FPGA circuitry 2300 of FIG. 23 may be in one or more packages. In some examples, an XPU may be implemented by the programmable circuitry 2112 of FIG. 21, which may be in one or more packages. For example, the XPU may include a CPU (e.g., the microprocessor 2200 of FIG. 22, the CPU 2320 of FIG. 23, etc.) in one package, a DSP (e.g., the DSP 2322 of FIG. 23) in another package, a GPU in yet another package, and an FPGA (e.g., the FPGA circuitry 2300 of FIG. 23) in still yet another package.

While an example manner of implementing the occupancy detection circuitry 420, 1600 of FIGS. 4, 5A, and 5B is illustrated in FIGS. 6 and 16, one or more of the elements, processes, or devices illustrated in FIGS. 6 and 16 may be combined, divided, re-arranged, omitted, eliminated, or implemented in any other way. Further, the occupancy detection circuitry 420, 1600 of FIGS. 4, 5A, 5B, 6, and 16, may be implemented by hardware alone or by hardware in combination with software and firmware. Thus, for example, any of the occupancy detection circuitry 420, 1600 of FIGS. 4, 5A, 5B, 6, and 16, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the occupancy detection circuitry 420, 1600 of FIGS. 4, 5A, 5B, 6, and 16 may include one or more elements, processes, or devices in addition to, or instead of, those illustrated in FIGS. 6 and 16, or may include more than one of any or all of the illustrated elements, processes and devices.

A flowchart representative of example machine-readable instructions, which may be executed to cause programmable circuitry to at least one of implement or instantiate the occupancy detection circuitry 420, 1600 of FIGS. 4, 5A, 5B, 6, and 16 or representative of example operations which may be performed by programmable circuitry to at least one of implement or instantiate the occupancy detection circuitry 420, 1600 of FIGS. 4, 5A, 5B, 6, and 16, are shown in FIG. 11. The machine-readable instructions may be one or more executable programs or portion(s) of one or more executable programs for execution by programmable circuitry such as the programmable circuitry 2112 shown in the example processor platform 2100 described below in connection with FIG. 21 and may be one or more function(s) or portion(s) of functions to be performed by the example programmable circuitry (e.g., an FPGA) described below in connection with FIG. 22 or 23. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non- volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 11, many other methods of implementing the occupancy detection circuitry 420, 1600 of FIGS. 4, 5A, 5B, 6, and 16 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs and/or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 11 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

What is claimed is:

1. A method comprising:
computing a difference metric between first sensed data and second sensed data, wherein the first sensed data is associated with a first region in a field of view of a sensor, and wherein second sensed data is associated with a second region in the field of view;
determining that the first sensed data is distinguishable from the second sensed data using the difference metric; and
detecting occupancy in the first region in response to determining that the first sensed data is distinguishable from the second sensed data.

2. The method of claim 1, wherein no occupancy is expected in the second region.

3. The method of claim 1, further comprising:
computing a mean for the second sensed data; and
computing a distribution metric for the second sensed data,
wherein computing the difference metric comprises computing the difference metric using the first sensed data, the mean for the second sensed data, and the distribution metric for the second sensed data.

4. The method of claim 1, wherein determining that the first sensed data is distinguishable comprises:
determining that the difference metric exceeds a threshold; and
determining that the first sensed data is distinguishable from the second sensed data in response to determining that the difference metric exceeds the threshold.

5. The method of claim 1, wherein determining that the first sensed data is distinguishable comprises determining that the first sensed data is anomalous compared to the second sensed data using the difference metric.

6. The method of claim 1, wherein determining that the first sensed data is distinguishable comprises determining that the first sensed data is distinct from the second sensed data using the difference metric.

7. The method of claim 1, determining that the first sensed data is distinguishable comprises determining that the first sensed data is an outlier compared to the second sensed data using the difference metric.

8. The method of claim 1, further comprising:
computing first Doppler data using the first sensed data; and
computing second Doppler data using the second sensed data,
wherein computing the difference metric comprises computing the difference metric between the first Doppler data and the second Doppler data.

9. The method of claim 1, further comprising:
computing first signal-noise ratio (SNR) data using the first sensed data; and
computing second SNR data using the second sensed data,
wherein computing the difference metric comprises computing the difference metric between the first SNR data and the second SNR data.

10. The method of claim 1,
wherein the sensor is an in-cabin vehicle radar,
wherein a center console of a vehicle is within the second region, and
wherein at least one of a window, a driver seat, or a passenger seat of the vehicle is within the first region.

11. The method of claim 1,
wherein the sensor is an in-cabin vehicle radar,
wherein a passenger seat of a vehicle is within the first region,
wherein a driver seat of the vehicle is within the second region, and
wherein the detecting occupancy comprises determining occupancy of an infant within the first region using the difference metric.

12. At least one non-transitory computer readable storage medium comprising instructions that, when executed, cause programmable circuitry to at least:
compute a difference metric between first sensed data and second sensed data, wherein the first sensed data is associated with a first region in a field of view of a sensor, and wherein second sensed data is associated with a second region in the field of view;
determine that the first sensed data is distinguishable from the second sensed data using the difference metric; and
detect occupancy in the first region in response to determining that the first sensed data is distinguishable from the second sensed data.

13. The at least one non-transitory computer readable storage medium of claim 12, wherein the instructions are to cause the programmable circuitry to:
compute a mean for the second sensed data; and
compute a distribution metric for the second sensed data, wherein computing the difference metric comprises computing the difference metric using the first sensed data, the mean for the second sensed data, and the distribution metric for the second sensed data.

14. The at least one non-transitory computer readable storage medium of claim 12, wherein determining that the first sensed data is distinguishable comprises:
determine that the difference metric exceeds a threshold; and
determine that the first sensed data is distinguishable from the second sensed data in response to determining that the difference metric exceeds the threshold.

15. The at least one non-transitory computer readable storage medium of claim 12, wherein the instructions are to cause the programmable circuitry to:
compute first Doppler data using the first sensed data; and
compute second Doppler data using the second sensed data,
wherein computing the difference metric comprises computing the difference metric between the first Doppler data and the second Doppler data.

16. The at least one non-transitory computer readable storage medium of claim 12, wherein the instructions are to cause the programmable circuitry to:
compute first signal-noise ratio (SNR) data using the first sensed data; and
compute second SNR data using the second sensed data,
wherein computing the difference metric comprises computing the difference metric between the first SNR data and the second SNR data.

17. A method comprising:
determining a distribution metric of first radar data associated with a reference zone;
determining a difference metric between the distribution metric of the first radar data and second radar data associated with a target zone; and
detecting occupancy in the target zone using the difference metric.

18. The method of claim 17, further comprising:
computing a mean for the second radar data; and
computing the difference metric for the second radar data, wherein determining the difference metric comprises computing the distribution metric using the first radar data, the mean for the first radar data, and the mean metric for the second radar data.

19. The method of claim 17,
wherein a center console of a vehicle is within the reference zone, and
wherein at least one of a window, a driver seat, or a passenger seat of the vehicle is within the target zone.

20. The method of claim 17,
wherein a passenger seat of a vehicle is within the target zone,
wherein a driver seat of the vehicle is within the reference zone, and
wherein the detecting occupancy comprises determining occupancy by an infant within the target zone using the difference metric.
